(19) United States
(12) Patent Application Publication
(10) Pub. No.: US 2022/0125090 A1
(43) Pub. Date: Apr. 28, 2022

(54) FRIED SNACK CHIPS AND METHODS OF FORMING THEM

(71) Applicant: Outstanding Foods, Inc., Santa Monica, CA (US)

(72) Inventors: David K. ANDERSON, Santa Monica, CA (US); William R. GLASER, Santa Monica, CA (US)

(21) Appl. No.: 17/285,090

(22) PCT Filed: Jul. 30, 2019
(86) PCT No.: PCT/US2019/044158

§ 371 Date: Apr. 13, 2021

Related U.S. Application Data
(63) Continuation of application No. 16/049,544, filed on Jul. 30, 2018.

(51) Int. Cl. A23L 31/00; A23L 5/10; A23L 33/125; A23L 33/20

(52) U.S. Cl. CPC A23L 31/00; A23L 5/11; A23L 33/125; A23L 33/20; A23V 2002/00; A23V 2200/209; A23V 2250/5114; A23V 2300/10; A23V 2300/24; A23V 2300/31; A23V 2300/38

(57) ABSTRACT

Fried snack chips formed Pleurotus eryngii mushrooms having a low fat content and methods of making them. The pleurotus Slicing the material (e.g., a stipe of a fruiting body of a Pleurotus eryngii mushroom eryngii mushroom snack chips described herein may have a meat-like transverse to the stipe) at a thickness of between 1-3 mm flavor rich in umami and may have less than 40% fat by weight, despite being fried in oil.

### CROSS REFERENCE TO RELATED APPLICATIONS

This patent application claim priority to U.S. patent application Ser. No. 16/049,544, filed on Jul. 30, 2018, titled “FRIED PLEUTROTUS ERYNGII SNACK CHIPS AND METHODS OF FORMING THEM” and herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Described herein are fried snack chips having a low fat content and methods of manufacturing them. In particular, described herein are fried snack chips made from Pleurotus eryngii and processes for producing them to produce a lower fat content.

### BACKGROUND

Edible mushrooms have been in widespread use as a popular food ingredient for many centuries. Mushrooms are used as an ingredient in numerous recipes, both raw and cooked. Although attempts have been made to prepare mushrooms in a chip (or “crisp”) form, particularly by frying, to date such attempts have met with limited success, and have been found to lack texture (including crispiness), flavor and visual appeal. Further, such chips, when fried, typically have a relatively high fat content. Mushrooms in particular are known to absorb a high degree of fat during processing in oils, and retain this fat in the resulting chip.

Frying, and particularly frying in oil, has been blamed for many of the problems associated with mushroom-based snack foods. See, e.g., Chinese patents CN102028192, CN102894350, CN102940028, CN101919529, and CN101933617, which assert that frying in oil (“high temperature frying”) processing results in a loss of nutrients, severe loss of flavor, high fat content, longer processing times and overall product taste and color. These patents have alleged to address these problems by incorporating alterative preparation methods, including vacuum microwave technology, freezing/microwaving, low-temperature treating and ultrasonic starch impregnation, and the use of dehydrated and powdered mushrooms (combined with starch).

These proposed methods may still produce chips that lack many of the desired properties, and may require costly, difficult and time-consuming processing steps.

Thus, it is highly desirable to provide snack chips formed of a mushroom material that is flavorful, particularly for meat-like flavors, crispy without being brittle, and visually appealing. Ideally these chips should be consistent in size, texture and taste, while being easy to prepare. Described herein are methods for producing a mushroom snack chip that may address these needs while avoiding the problems discussed above.

### SUMMARY OF THE DISCLOSURE

Described herein are crispy snack chips having a meaty flavor, and methods of forming such crispy snack chips.

In general, the crispy snack chips described herein may have a highly controlled and relatively low fat content, despite being processed in oil. Further, these chips may have a desirable meat-like flavor rich in umami. These chips may be processed to have a smoked flavor, and may be crunchy without being crumbly (e.g., overly brittle) or “styrofoamy” (e.g., have a slightly compressible, then breakable texture). Although the chips described herein may be formed almost exclusively from mushrooms, and in particular Pleurotus eryngii mushrooms, they may lack a distinct mushroom flavor, which may be desirable. In some variations the chips may be made from other vegetable matter, including tubers such as potatoes, sweet potatoes, or the like.

In particular, the snack chips described herein may have a fat content that is substantially lower than other mushroom chips, even when prepared by frying. Specifically, the snack chips described herein may have a fat content that is less than about 40%. In some variations the chips may be processed so that fat is displaced or limited from impregnating the chips by including one or more displacing agents (e.g., fat displacing or fat blocking agents, also referred to herein as blocking agents or displacing/blocking agents), e.g., polysaccharides (e.g., maltodextrin), starches (e.g., pregelatinized starches as described herein) that may be absorbed into the mushroom prior to cooking (e.g., frying). The absorbed displacing agent (e.g., pregelatinized starch) may be within a desired range absorbed into the chip (e.g., between about 0.1% and 20%, e.g., between 0.5% and 15%, between about 1% and 10%, between about 2% and 7%, etc., greater than 0.1%, greater than 0.5%, greater than 1%, greater than 1.5%, greater than 2%, etc.). The displacing agent may be absorbed throughout the entire internal volume of the chip, either uniformly or non-uniformly, and is not limited to the outer surface; in some variations additional polysaccharide may be added to the surface after cooking.

As will be described in greater detail below, the methods described herein provide specific steps and ranges of values that result in a snack chip having these desirable properties (flavor, crispiness, etc.); outside these described ranges or variations in these steps may produce chips that lack one or more of the desired properties. The desired properties such as flavor and crispness arise from the surprising combination of mushroom type, slice thickness, slice orientation relative to the stipe of the mushroom, impregnating with a displacing agent, frying in oil at high temp range and in some variations, brief smoking. Varying one or more of these parameters typically results in a chip that is not either overly brittle, Styrofoamy or chewy, and that tastes too mushroomy, tastes unpleasantly bitter, has an undesirably high fat content, and/or is otherwise lacking.

Typically the methods described herein may include slicing a stipe region of a fruiting body of a Pleurotus eryngii mushroom so that it is transverse to the elongate stipe of the Pleurotus eryngii, e.g., at an angle of approximately 90° (+/− approximately 30°, 25°, 20°, 15°, etc.) relative to the long axis of the stipe, to form a plurality of slices having an initial thickness that is less than 4 mm (e.g., between 1 mm and 3 mm). Slices may then be treated with a displacing agent, such as pregelatinized starch, to impregnate the slices with the displacing agent (e.g., soaking in an aqueous solution of, e.g., between about 5%-40% pregelatinized starch for between about 30 seconds and 30 minutes, between 2 minutes-20 minutes, etc.). These slices may then be fried in oil at a high temperature (e.g., between 145° C. and 190° C.) at normal pressure until the water activity (a_{w}) of the plurality of slices is less than 0.85 (e.g., 0.8 or less, 0.7 or less, 0.65 or less, 0.6 or less, etc.). The fried slices may thereafter be de-oiled (e.g., by spinning/centrifugation and/or blotting). The fried slices may then be rapidly saturated in a wood smoke by exposing the chips (e.g., in a smoker) for a controlled amount of time less than 10 minutes (e.g., less than 9 minutes, less than 8 minutes, less than 7 minutes, less than 6 minutes, between about 1 min and 8 minutes, between about 1 minutes and 10 minutes, between about 2 minutes and 10 minutes, etc.). The wood smoke may be generated at a temperature of between about 90° C. and 130° C. The plurality of slices has a final thickness of between 0.7 mm and 2.2 mm and a diameter of between about 2 cm and 5 cm. Additional salts or other flavors may be added. Prior to slicing, the mushrooms may be pre-treated, e.g., by exposing to air at room temperature (e.g., between 65 degrees F. and 75 degrees F., e.g., about 70 degrees F.) for a predefined time period (e.g., between 1 hour and 36 hours) and then storing at lower temperature (e.g., between 30 degrees F. and 50 degrees F., e.g., about 40 degrees F.) for up to 7 or 8 days (e.g., between 3-5 days) prior to slicing.

The combination of parameters used to form these chips (e.g., the slice thickness, slice orientation, frying time/temp, smoking time and in some variations pre-treatment with a low-oxygen environment) described surprisingly define a specific range of values that result in chips having the desired crispiness, texture (e.g., “mouthfeel”) and flavor.

For example, described herein are methods of forming crisp snack chips having a meat flavor, the method comprising: slicing a stipe of a fruiting body of a Pleurotus eryngii mushroom transverse to the stipe at 90°+/−30° (e.g., +/−25°, 20°, 15°, 10°, etc.) relative to the long axis of the stipe to form a plurality of slices having an initial thickness of between 1 mm and 3 mm; frying the plurality of slices at ambient pressure in oil at between 145° C. and 190° C. until the water activity (a_{w}) of the plurality of slices is 0.6 or less; and saturating the plurality of slices in a smoke for between 2 and 10 minutes; wherein the plurality of slices have a final thickness of between 0.7 mm and 2.2 mm and a diameter of between about 2 cm and 5 cm.

The slicing the fruiting body may comprise removing or omitting any of a cap portion of the fruiting body from the plurality of slices, so that the slices do not include any portion of the cap region of the mushroom.

Frying of the slices may comprise frying until the water activity is within the desired (e.g., less than 0.8, less than 0.7, less than 0.6), e.g., for between 2 minutes and 6 minutes. The step of frying may comprise frying in any appropriate oil, including one or more of: corn oil, safflower oil, sunflower oil, soybean oil, cotton seed oil, and sesame seed oil, avocado oil, olive oil, peanut oil, canola oil, algae oil, almond oil, organ oil, coconut oil, rice bran oil, flax seed oil, grape seed oil, hemp oil, mustard oil, macadamia oil, palm oil, peanut oil, pumpkin seed oil, soybean oil, tea seed oil, and walnut oil.

Optionally, any of these methods may alternatively or additionally include baking. For example, in some variations, an optional post-frying drying (baking) step may be included after the frying step, which may allow frying for less time. For example, the chips may be spend little less time in the fryer and be finished in the oven, which may allow for further fat reduction, as well as producing a consistent and uniform color and appearance. Baking may be performed at, for example, a temperature range in the oven of between about 93.3° C. and 176.7° C., for between about 6 minutes-20 minutes (or until the desired final water content is achieved).

The chips may optionally be saturated in the smoke. Saturating the plurality of slices in the smoke may comprise forming the smoke from one or more of: cherry wood, hickory wood, apple wood, alder wood, mesquite wood, oak wood, peach wood, pecan wood, maple wood, bourbon barrel wood, almond wood, apricot wood, pear wood, pinion wood, cedar wood, guava wood, mulberry wood, olive wood, plum wood, orange wood, and walnut wood. As used herein “saturating” may include holding the chips in intimate contact (e.g., surrounded by) the smoke) for the predetermined time period. For example, saturating the plurality of slices in the smoke may comprise saturating the plurality of slices in a smoke generated at between 90° C. and 130° C.

Any of these methods may optionally include washing and peeling of the stipe of the fruiting body prior to slicing. Additionally or alternatively, the methods may include blanching the plurality of slices prior to frying them, and/or dehydrating the plurality of slices prior to frying them.

As already mentioned above, any of these methods may include de-oiling the plurality of slices after frying them. Any appropriate method of de-oiling may be used, including blotting, spinning (e.g., centrifugation), etc. For example, de-oiling may comprise centrifuging the plurality of slices.

Any of these methods may include seasoning the plurality of slices, typically after frying and/or after smoking. For example, seasoning may include seasoning with maple crystals. Seasoning may include seasoning the plurality of slices with maple crystals and sea salt in a ratio of between 1:2 and 1:6 (e.g., between 1:3 and 1:5, approximately 1:2, 1:3, 1:4, 1:5, 1:6, etc.). Examples of seasoning may include seasoning the plurality of slices with one or more of: maple crystals, sea salt, and cheese flavor. Meat (e.g., chicken, beef, pork, fish, etc.) flavors may be used, although in some variations meat flavors are not necessary and may be explicitly excluded.

Alternatively or additionally, the chips may be seasoned with a smoked maltodextrin powder that may be applied to the chips topically, along with the other seasonings, after they are fried and/or baked.

A method of forming crispy snack chips having a meat flavor may include: slicing a stipe of a fruiting body of a Pleurotus eryngii mushroom having a diameter of between 3.5 cm and 8 cm transverse to the stipe at 90°+/−30° (e.g., +/−25°, 20°, 15°, 10°, 5°, 2°, etc.) relative to the long axis of the stipe to form a plurality of slices having an initial thickness of between 1 mm and 3 mm; impregnating with a displacing agent (e.g., pregelatinized starch), e.g., to an internal concentration of greater than 1% (e.g., greater than 2%, greater than 3%, between 0.5% and 10%, between 1% and 6%, between 2% and 5%, etc.), frying the plurality of slices at ambient pressure in oil at between 149° C. and 182° C. until the water activity (a_{w}) of the plurality of slices is 0.6 or less; wherein the plurality of slices have a final thickness of between 0.7 mm and 2.2 mm and a diameter of between about 2 cm and 5 cm. In some variations, the method may include saturating the plurality of slices in a smoke generated between 90° C. and 130° C. for between 1 and 8 minutes.

For example, a method of forming crisp (e.g., “crispy”) snack chips having a meat flavor may include: slicing a stipe of a fruiting body of a Pleurotus eryngii mushroom having a diameter of between 3.5 cm and 8 cm transverse to the stipe at 90°+/−30° relative to the long axis of the stipe to form a plurality of slices having an initial thickness of between 1 mm and 3 mm; frying the plurality of slices at ambient pressure in oil at between 149° C. and 182° C. until the water activity (a_{w}) of the plurality of slices is 0.6 or less; (optionally seasoning the plurality of chips with maple crystals and sea salt in a ratio of between 1:3 to 1:5) wherein the plurality of slices have a final thickness of between 0.7 mm and 2.2 mm and a diameter of between about 2 cm and 5 cm.

A method of forming a crisp mushroom snack chip having a savory flavor may include: slicing a stipe of a fruiting body of a Pleurotus eryngii mushroom transverse to a stipe at 90°+/−30° relative to a long axis of the stipe to form a plurality of slices having an initial thickness of between 1 mm and 3 mm; soaking the sliced mushrooms in a solution comprising between 1% and 25% of pregelatinized starch; and frying the soaked sliced mushrooms at ambient pressure in oil having a temperature between 157° C. and 185° C. to reduce the water activity of the sliced mushrooms, wherein the sliced and fried mushrooms have a final thickness of between 0.7 mm and 2.2 mm and a diameter of between about 2 cm and 5 cm, a water activity of 0.6 or less, and a fat content of less than 40%. The fat content may range from 30% and 40%. The sliced mushrooms may be soaked until the sliced mushrooms contain between 3% and 6% of the pregelatinized starch. The solution may have a temperature of between 20° C. and 60° C. The method may further include removing the sliced mushrooms from the solution and allowing the soaked mushrooms to rest outside of the solution for a time ranging from 1 minute and 10 minutes prior to frying. The sliced mushrooms may be soaked in the solution for a time ranging from 1 minute and 120 minutes. The sliced mushrooms may be soaked in the solution for between 1 minute and 30 minutes. The sliced mushrooms may be soaked in the solution for between 1 minute and 10 minutes. The pregelatinized starch may be derived from corn. The pregelatinized starch may be a low viscosity pregelatinized starch. The method may further include agitating the slices mushrooms while in the solution. The pregelatinized starch has a dextrose equivalent no greater than about 5%.

A method of forming a mushroom snack having a savory flavor may include: soaking a mushroom in a solution comprising between 1% and 25% of pregelatinized starch; and frying the soaked mushroom at ambient pressure in oil having a temperature between 157° C. and 185° C. to reduce the water activity of the mushroom, wherein the fried mushroom has a fat content of no greater than 45%. The fat content may range from 30% and 40%. The method may further include slicing the mushroom prior to soaking. The mushroom may be soaked and fried in whole. The mushroom may be a king oyster mushroom, a button mushroom or a shitake mushroom. The mushroom may be a king oyster mushroom, and the method may further include slicing the mushroom prior to soaking, wherein the slicing includes slicing transverse to a stipe of the mushroom at 90°+/−30° relative to a long axis of the stipe to form a plurality of slices having an initial thickness of between 1 mm and 3 mm, wherein the plurality of slices may have a final thickness of between 0.7 mm and 2.2 mm and a diameter of between about 2 cm and 5 cm, and a water activity of 0.6 or less after the frying. The method may further include tumbling the mushroom under vacuum to reduce a moisture content of the mushroom prior to soaking.

The mushroom may be soaked until the mushroom contains between 3% and 6% of the pregelatinized starch. The solution may have a temperature of between 20° C. and 60° C. The pregelatinized starch may have a dextrose equivalent no greater than about 5%.

A crisp mushroom snack chip having a savory flavor may include: a body comprising a fried Pleurotus eryngii mushroom sliced transverse to the stipe at 90°+/−30° relative to the long axis of the stipe having a thickness of between 0.7 mm and 2.2 mm and a diameter of between about 2 cm and 5 cm; wherein the chip comprises: 3%-6% of pregelatinized starch absorbed therein and an oil content less than 40%. The body may have between 3%-6% pregelatinized starch absorbed therein. The chip may have a water activity of 0.6 or less. The chip may include a seasoning applied to an outer surface of the chip, such as a smoked pregelatinized starch powder. The color of the body, in the CIELAB color space, may have a lightness value (L*) of greater than 55 and a chroma (a*/b*) of less than about 0.3.

For example, described herein are methods of forming mushroom snack chips using a continuous process that may include: slicing a stipe of a fruiting body of a Pleurotus eryngii mushroom transverse to the stipe at 90°+/−30° relative to the long axis of the stipe to form a plurality of slices having an initial thickness of between 1 mm and 3 mm; soaking the plurality of slices in a solution of pregelatinized starch for greater than 7 minutes until the plurality of slices are impregnated with between 1%-6% of pregelatinized starch; frying the plurality of slices at ambient pressure in oil at between 168° C. and 185° C. to reduce the water activity of the plurality of slices; and wherein the plurality of slices have a final percentage of fat by weight of less than 40%, and a water activity of 0.6 or less. Soaking may include soaking in an aqueous solution of greater than 10% pregelatinized starch at less than 25 degrees C. for greater than 7 minutes. Any of these methods may include resting the plurality of slices prior to frying for between 2 minutes and 30 minutes. Further, any of these methods may include continuously repeating the steps of slicing, soaking and frying using the same oil for frying, for at least six hours.

Also described herein are methods of forming crisp mushroom snack chips having a savory flavor, the method comprising: normalizing a Pleurotus eryngii mushrooms by exposing to air at between 65° F. and 75° F. for approximately 24 hours and refrigerating for up to eight days; slicing a stipe of a fruiting body of the Pleurotus eryngii mushroom transverse to the stipe at 90°+/−30° relative to the long axis of the stipe to form a plurality of slices having an initial thickness of between 1 mm and 3 mm; soaking the plurality of slices in a solution of 10% or more of pregelatinized starch for greater than 6 minutes to impregnate the plurality of slices for 7 minutes or more until the plurality of slices each contain between 1%-6% of pregelatinized starch; frying the plurality of slices at ambient pressure in oil at between 168° C. and 185° C. to reduce the water activity of the plurality of slices; and seasoning the plurality of slices, wherein the plurality of slices have a final thickness of between 0.7 mm and 2.2 mm and a diameter of between about 2 cm and 5 cm, a water activity of 0.6 or less, and a percent of fat by weight of 40% or less.

Also described herein are crisp mushroom snack chips having a savory flavor, the chip comprising: a body comprising a fried Pleurotus eryngii mushroom sliced transverse to the stipe at 90°+/−30° relative to the long axis of the stipe having a thickness of between 0.7 mm and 2.2 mm and a diameter of between about 2 cm and 5 cm; wherein the body has between 5%-20% pregelatinized starch absorbed therein; wherein the chip has less than 38% oil; further, wherein the chip has a water activity of 0.6 or less. For example, the body may have between 2%-65 pregelatinized starch absorbed therein.

Also described herein are methods of forming a crisp mushroom snack chip having a savory flavor, the method comprising: slicing a stipe of a fruiting body of a Pleurotus eryngii mushroom transverse to a stipe at 90°+/−30° relative to a long axis of the stipe to form a plurality of slices having an initial thickness of between 1 mm and 3 mm; soaking the sliced mushrooms in a solution comprising between 1% and 25% of pregelatinized starch; and frying the soaked sliced mushrooms at ambient pressure in oil having a temperature between 157° C. and 185° C. to reduce the water activity of the sliced mushrooms, wherein the sliced and fried mushrooms have a final thickness of between 0.7 mm and 2.2 mm and a diameter of between about 2 cm and 5 cm, a water activity of 0.6 or less, and a fat content of less than 40%.

For example, a method of forming a mushroom snack may include: soaking a mushroom in a solution comprising between 1% and 25% of pregelatinized starch; and frying the soaked mushroom at ambient pressure in oil having a temperature between 157° C. and 185° C. to reduce the water activity of the mushroom, wherein the fried mushroom has a fat content of no greater than 47%.

Also described herein are crisp mushroom snack chips having a savory flavor, the chip comprising: a body comprising a fried Pleurotus eryngii mushroom sliced transverse to the stipe at 90°+/−30° relative to the long axis of the stipe having a thickness of between 0.7 mm and 2.2 mm and a diameter of between about 2 cm and 5 cm; wherein the chip comprises: 3%-6% of pregelatinized starch absorbed therein and an oil content less than 40%.

Any of the methods described herein may be applied to making a potato chip rather than a mushroom chip, as described herein.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1A illustrates an exemplary method of forming the chips described herein.

FIG. 1B illustrates an exemplary method of forming the chips described herein.

FIGS. 2 and 3 illustrate exemplary slices of Pleurotus eryngii mushrooms that are approximately 4-6 cm diameter (e.g., 4.5-5.5 cm diameter). These slices are taken transverse to the stipe of a fruiting body of a Pleurotus eryngii mushroom at approximately 90° relative to long axis of the stipe. These slices are taken at approximately 2 mm thickness (+/−15%, 10%, 5%, etc.). FIG. 2 shows a front view (showing the diameter of the two exemplary oval/rounded chips) and FIG. 3 shows one of these slices from the side, showing the thickness of approximately 2 mm.

FIG. 4 shows the slices of FIGS. 2 and 3 fried in oil as described herein (e.g., between 145° C. and 190° C.) to form chips.

FIG. 5 shows the chips of FIG. 4 being de-oiled by blotting on a paper material.

FIG. 6 shows a comparison between six different sizes of slice transverse to the stipe of a Pleurotus eryngii mushroom: 1 mm (A), 2 mm (B), 2.5 mm (C), 3 mm (D), 3.5 mm (E), and 4 mm (F).

FIG. 7 shows the fried version of chips formed from each of the six different sizes of slices shown in FIG. 6 for comparison: 1 mm (A), 2 mm (B), 2.5 mm (C), 3 mm (D), 3.5 mm (E), and 4 mm (F). These slices were tested for crispiness, taste, mouthfeel, etc.

FIG. 8 shows a comparison between slices taken at different angles relative to the long axis of stipe of a Pleurotus eryngii mushroom for comparison. For example, a section through the stipe may be taken at 90° (A), 45° (B) or 0° (C.). Different thicknesses may be tested. In FIG. 8, the slices were 2 mm thick prior to frying.

FIG. 9 shows chips formed by frying the slices taken at different angles relative to the long axis of stipe of a Pleurotus eryngii mushroom shown in FIG. 8 (e.g., taken at 90° (A), 45° (B) or 0° (C.) relative to the long axis of the stipe). These chips were tested for crispiness, taste, mouthfeel, etc.

FIGS. 10, 11 and 12 illustrate transverse, 2 mm-thick slices taken through the stipe-only region of a Pleurotus eryngii mushroom after slicing but before frying (FIG. 10), after frying (FIG. 11) and after exposing to smoke (post-smoking, FIG. 12).

FIG. 13 graphically illustrates an example of a comparison of the resulting crispiness of chips formed by frying (at high temperature) between different thicknesses of slices taken transverse to the stipe of a Pleurotus eryngii mushroom, similar to the chips shown in FIGS. 6 and 7. In FIG. 13 the relative and subjectively evaluated crispiness is shown on the vertical access, including styrofoamy, crispy and brittle. A desirable amount of crispiness is represented by the dashed horizontal lines.

FIG. 14 graphically illustrates an example of a comparison of the resulting crispiness of chips formed by frying (at high temperature) between different angles of slices taken relative to the stipe of a Pleurotus eryngii mushroom, similar to the chips shown in FIGS. 8-9. In FIG. 14 the relative and subjectively evaluated crispiness is shown on the vertical access, including styrofoamy, crispy and brittle. A desirable amount of crispiness is represented by the dashed horizontal lines.

FIG. 15 graphically illustrates the effect of smoking time on flavor when smoking chips formed as descried above (e.g., 2 mm thick, sliced transverse to the stipe, fried at high temperature). In FIG. 15 the vertical axis shows the relative and subjectively evaluated flavor axis (extending from unsmoked, smoky, bitter and creosote). The horizontal lines in FIG. 15 illustrate transitions between smoky and bitter and bitter and creosote; an ideal flavor profile is typically highly smoky without being bitter.

FIG. 16 illustrates an exemplary method of forming the chips described herein.

### DETAILED DESCRIPTION

Described herein are methods of forming fried chips from plants and mushrooms using a frying process that results in chips having a substantially lower fat content than previously described frying techniques. In particular, described herein are fried mushroom chips that may be commercially produced in a consistent, reproducible and cost-effective manner that provides a product having a high quality, pleasing taste, and desired shelf life and a low fat content. In particular, the chips described herein may include a distribution of a blocking agent, an in particular a pre-gelatinized, low viscosity corn starch blocking agent (such as, e.g., PURE-COTE B792, a modified food starch produced by the Grain Processing Corporation of Muscatine, Iowa, or similar modified, pregelatinized starches that are water soluble below 25 degrees C.) within the chips prior to frying. A distribution of a blocking agent of between about 1% to 20% prior to frying (resulting in a final distribution of blocking agent of between 2% to 40%) may result in 40% or less of fat when frying the mushrooms in an oil at relatively high heat. In particular, the resulting chips may have a distribution of pregelatinized starch such that is greater than 4% within the fried chip. The chips may also include the oil in which it was fried.

Early experiments indicated that the type of mushroom and the location of the slice from which the mushroom was taken were important in achieving consistent flavor and crispiness. Pleurotus eryngii mushrooms, also referred to as king oyster mushrooms, were found to work consistently well. Other types of mushrooms including button mushrooms and shitake mushrooms produced chips that were undesirable, not sufficiently crispy and/or lacking in flavor. Pleurotus eryngii mushrooms typically include an elongate stem region, referred to as the stipe, and end in a relatively small cap. Mushrooms having a diameter of greater than 3 cm (e.g., between 3-7 cm, between 4-6 cm, e.g., between 4.5 and 5.5 cm) were found to have the best results. The large stems of these mushrooms typically include a fibrous structure that extends along the long axis. As will be described in detail below, the angle of slices taken through the stipe (relative to the long axis of the stipe) has a profound effect on the crispiness and flavor profile of the resulting fried chips.

Originally, mushrooms were processed as described above, e.g. by slicing, frying, e.g., at 325 degrees F., seasoned and smoked for flavor. Unfortunately, this results in a very inconsistent chip. Sometimes the chips had an appealing golden-brown color, desirable texture and flavor. Other times the chips were very dark and the flavor and texture were off. In order to address the inconsistency in the resulting chip, described herein are processing methods including “ripening” the mushrooms prior to slicing them by resting them in air for a period of time (e.g., >4 hours, 5 hours, 6 hours, 7 hours, 8 hours, 9 hours, 10 hours, 12 hours, etc.) before slicing them, such as leaving them in a 40 degrees F. refrigerator for 1 week or left at 65 degrees F. overnight). The mushrooms may then be sliced, fried (e.g., 325 degrees F.), and seasoned (salted, smoked, etc.). The Ripening process may create a consistent chip having an appealing golden-brown color, desirable texture and flavor. However, such chips may have a high fat content, such as between 50-60% fat. It may be desirable to instead have a fat percentage of about 37% or lower.

Thus, described herein are chips and methods of manufacturing them that include impregnating the raw (uncooked) and sliced chip with a blocking agent such as a pregelatinized starch (e.g., PURE COTE B792) prior to frying at relatively high heat. In some variations the blocking agent may include maltodextrins. Preferably, the blocking agent may be a pregelatinized starch that is water soluble at lower than room temperature (e.g., 25 degrees C. or less), as it is preferable to soak the uncooked sliced chips in the blocking agent at room temperature or lower, as this surprisingly aids in uniform absorption.

Although blocking agents that include sugars (e.g., maltodextrin) may be used, it may be preferable to use blocking agents that do not include sugars, as this may allow frying at higher temperature. For example, soaking chips for 7 minutes in a 10% pregelatinized starch/water solution), resting (3 minutes) them, and frying them at between about 300-315 degrees F. may result in a dark, burnt-tasting chip, although the fat content is between about 32-37% fat.

In some variations, the use of a pregelatinized starch that is water soluble at lower than room temperature (e.g., 25 degrees C. or less) may allow cooking at higher frying temperatures (e.g., 315 degrees F. and higher) while resulting in a more uniformly colored and tasting chip, without burning. Although many blocking agents were tested (e.g., starches and flours, proteins, sugars and alcohols), those that were not cold-water soluble, or that had a high viscosity proteins (not cold-water soluble), typically resulted in chips that burned at ambient fryer temperatures (e.g., 300 degrees F. and higher). Although maltodextrin is cold water soluble and did not burn at ambient fryer temperatures (e.g., up to 315 degrees), it proved difficult to use for a continuous manufacturing technique, perhaps because of the sugar level of maltodextin. The proper maltodextrin concentration in the solution, e.g., the amount of blocking agent, must also be optimized to (e.g., by controlling the soak time and soak concentration as well as the rest time) to produce a chip within the desired fat percentage (e.g., 32-37%). Generally, the concentration of solids in the solution of blocking agent may be measured by a refractometer.

For example, chips that were formed following ripening (e.g., leaving in a 40 degrees F. refrigerator for 1 week or left at 65 degrees F. overnight), by slicing them impregnating with a low-viscosity, cold-soluble (e.g., 25 degrees C. or colder) blocking agent (such as soaking for 7 minutes in a 10% maltodextrin/water solution), prior to resting (e.g., for 3 minutes) then frying at low heat (e.g., at 300-315 degrees F.) resulted in a consistently colored chip having a fat content of 37% or less.

However, when the process of producing such chips is scaled up, it may be desirable to use a higher frying temperature, such as greater than 315 degrees C. As mentioned, although the use of a blocking agent such as maltodextrin may be used, this typically requires a lower frying temperature of between about 300-315 degrees F., and, when run continuously, may result in a build-up in fryer oil and reach caramelization point. This may cause the fryer to clog.

Thus, in some variations it may be desirable to form the fried chips (e.g., fried mushroom chips) by optionally pre-treating the unsliced mushrooms (“ripening” them) in an ambient air environment (e.g., left in 40 degrees F. refrigerator for 1 week or left at 65 degrees F. overnight), slicing them as described herein, impregnating them with a pregelatinized starch that is water soluble at lower than room temperature (e.g., 25 degrees C. or less) such as by soaking them for between 5-30 minutes (e.g., between 5-10 minutes, between 5-9 minutes, etc.) in a modified food starch/water solution (e.g., having a percentage of pregelatinized starch that is between about 5% and 20%, e.g., between about 5% and 15%, between about 7% and 12%, about 9%, etc.), resting them (e.g., 1 minute or longer, 2 minutes or longer, 3 minutes or longer, 5 minutes or longer, 10 minutes or longer, e.g., between 1-10 minutes, between 2-7 minutes, etc.), and then frying them at relatively high heat, such as between about 315 and 375 degrees F. (e.g., between 325 and 370 degrees, between 340 and 360 degrees F., etc.). The chips may then be post-processed as described herein, including seasoning, smoking, de-oiling (blotting), etc. The resulting chips are typically uniform in flavor, texture, color and may have a fat content of less than 40%, and in particular, 37% or less. Further, these chips may be processed in a continuous processing manner for 8 hour or more without clogging the fryer. As mentioned, it is particularly useful to use a blocking agent that is a modified food starch that is cold-water soluble, having a low viscosity.

As mentioned above, a blocking agent may preferably be a modified food starch that is cold-water soluble, having a low viscosity. For example, the blocking agent may be a pregelatinized starch may be derived from any starch source, including, e.g., corn (e.g. cornstarch). The blocking agent ideally hydrates in cold water (e.g., below 25 degrees C., 24 degrees C., 23 degrees C., 22 degrees C., 21 degrees C., 20 degrees C., 18 degrees C., etc.), and stays in solution (e.g., for >12 hours, >16 hours, >20 hours, >24 hours, etc.). In general, the pregelatinized starch may have a low viscosity at relatively high solids; the viscosity may be less than about 60 mPa*s at 20° C. (e.g., less than about 50 mPa*s at 20° C., less than 40 mPa*s at 20° C., less than 30 mPa*s at 20° C., less than 25 mPa*s at 20° C., less than 20 mPa*s at 20° C., less than 15 mPa*s at 20° C., less than 10 mPa*s at 20° C., less than 5 mPa*s at 20° C., less than 4 mPa*s at 20° C., less than 3 mPa*s at 20° C., less than 2 mPa*s at 20° C., etc.).

In some variations, the blocking agent may have a very low sugar content (e.g., <2% sugar content, <1% sugar content, <0.5% sugar content, <0.1% sugar content, etc.). As mentioned above, examples of blocking agents comprising a pregelatinized starch may include, e.g., PURE COTE B792; other examples may include BatterCrisp Modified Food Starch (manufactured by Cargill), and Crisp Film Modified Food Starch (manufactured by Ingredion).

The cut slices of vegetable or mushroom material may be soaked in an aqueous solution of blocking agent, as described above. The soaking solution may be formed, for example, by mixing the blocking agent into water using high shear for several minutes. The solution may be formed at room temperature of cooler. The sliced material (e.g., sliced mushrooms) may be soaked for, e.g., between 3 minutes and 30 minutes (e.g., between 4 minutes and 12 minutes, between 5 minutes and 10 minutes, between 6 minutes and 9 minutes, etc.). As described below, the soaking time may be particularly important in impregnating the blocking agent into the un-fried slices, and therefore the ultimate fat content (fat percentage) of the final chips. Following the soak, the chips may be rested for a rest period, prior to frying. The duration of the rest period may be, e.g., between 1 and 20 minutes (e.g., between 2 and 10 minutes, between 3-7 minute, etc.). In some variations the total duration of both the soak and the rest period may be between 8 and 30 minutes (e.g., between 9 and 20 minutes, between 10 and 15 minutes, etc.). For example, in one variation, mushroom slices are soaked for 7 minutes in a 1%-25% solution of blocking agent followed by a 3 minute resting period out of the soak, prior to frying. The soaking concentration may be between 1% and 25% (e.g., 5% to 20%, e.g., between 7% and 13%, etc.). The soaking may be performed at room temperature (e.g., 25 degrees C. or less, e.g., 23 degrees C. or less, 20 degrees C. or less, etc.). In general, the inventors have found that soaking at cooler temperatures generally works better than soaking at warmer temperatures; the warmer the water, the less blocking agent may penetrate into the mushroom slices. In variations in which slices of other vegetables (e.g., potatoes, sweet potatoes, etc.) are used, the length of the soaking time may be extended (e.g., between 5 and 120 minutes, 10 and 100 minutes, etc.). In any of these variations, the soaking step may be replaced with or augmented by using a vacuum tumbling methods (e.g., removing air during the soaking period), which may reduce the soaking time (e.g., to between about 30 seconds and 30 minutes, between about 1 minute and 25 minutes, etc.).

Although it may be possible to very quickly impregnate the blocking agent into the slices (e.g., mushroom slices, potato slices, etc.), such as between about 3-10% of soaking agent absorbed into the slice, the total percentage absorbed may be less important than the distribution of the impregnation, particularly on reducing the fat content. For example, very brief, but high-concentration blocking agent soaks may result in, e.g., between 3% -6% of the blocking agent soaking into the slices even after just a few minutes. However, this may be misleading; generally, the shorter the amount of soak time, the less oil reduction when frying, even as compared to equivalent-duration soaking. For example, after soaking mushroom slices for approximately 3 minutes, the slices may pick up about 5% of the agent. However, after frying, the same mushroom slices may include about 45% oil. In contrast, when the mushroom slices are soaked for about 7 minutes they may still absorb about 5% of the agent, all other parameters being equivalent. However, after frying, the slices may include about 36% oil (within the target range). Thus, although the time of the soak is nearly identical, and although time is an important factor, it does not determine the final amount of the agent absorbed, including the distribution (e.g., impregnation) of the blocking agent within the slice.

Post soaking, the fried slices may rest at room temperature for a period of time, as mentioned above. Resting the soaked slices in this manner may allow the solution near the surface region of the slice to further absorb into the slices.

Once rested, the impregnated slices may be fried at a frying temperature of between 300 to 365 degrees F. (typically between 325-365 degrees F., etc.). As mentioned above, the use of pregelatinized (modified) starch as described herein may permit frying at reasonably higher temperatures, such as between 335 and 365 degrees F. for between 3-10 minutes (e.g., between about 4 to 8 minutes, between about 4-5 minutes, etc.).

As mentioned above, the fat content of the final, fried, chips may be controlled by the use of the blocking agent, and in particular the impregnation of the chip un-fried chip with the one or more blocking agents may be varies to modulate the percentage of fat to be less than about 37% (e.g., between about 20% and 37%, between about 30-37%, etc.). Chips made without any soaking (sliced, then immediately fried at 325 degrees F.) yielded an average oil content of 55%, so the blocking agent reduced the fat percentage by roughly 20 percentage points. There is definitely a correlation of soak time and/or blocking agent concentration to the percent fat reduction. Generally speaking, any increase in soak time and/or soak concentration will result in an increase in fat reduction, up to a point (e.g., approximately 20%).

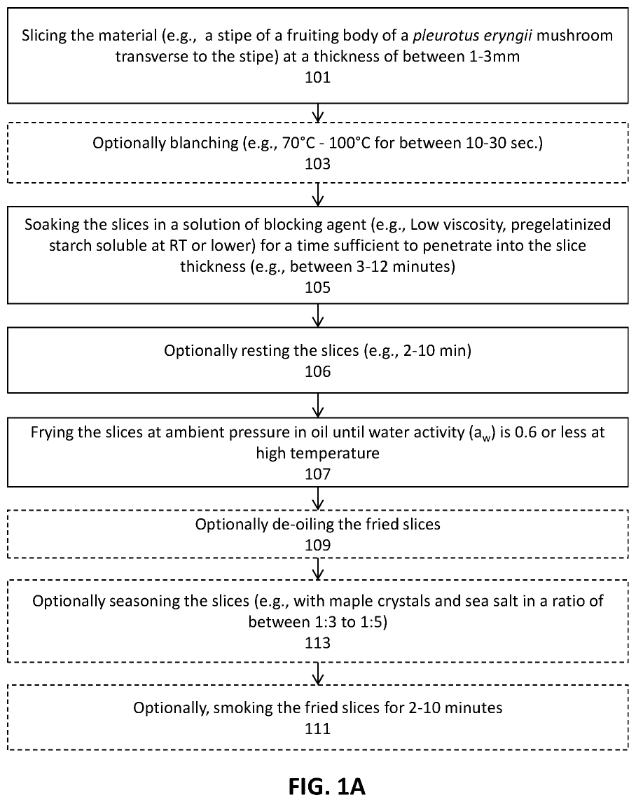

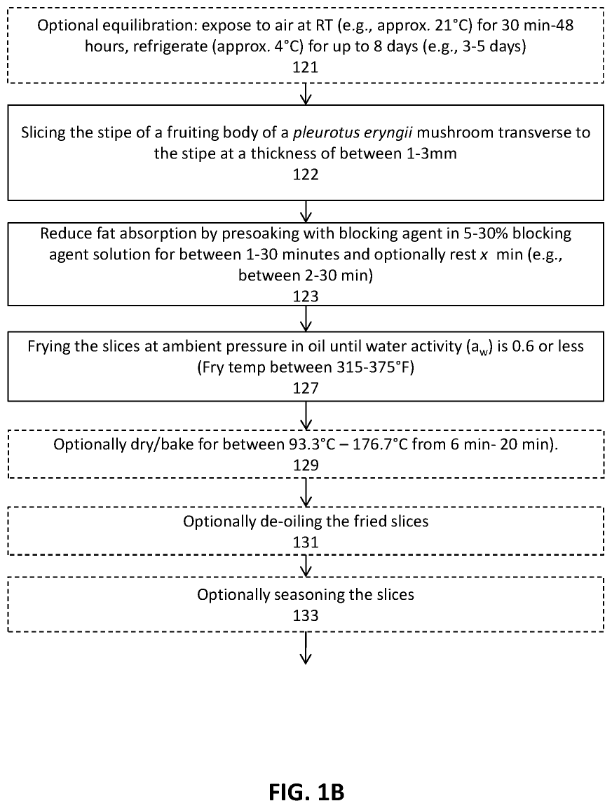

FIGS. 1A and 1B schematically illustrate methods for making the fried mushroom chips, include slicing the Pleurotus eryngii mushroom, optional washing/drying before or after slicing, frying the slices in an oil until the water activity of the slices is below a predetermine threshold, optionally de-oiling the resulting chips, smoking the chips for a controlled brief period (e.g., <10 minutes) and optionally seasoning the chips. However, specific aspects of this general method may be important to control the desired flavor and/or texture, including crispiness.

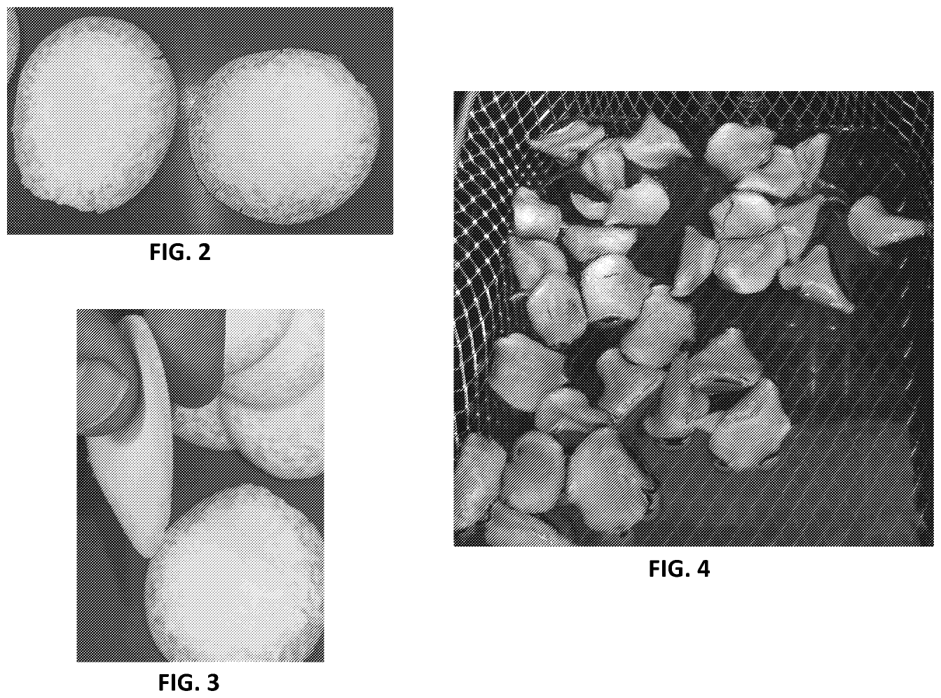

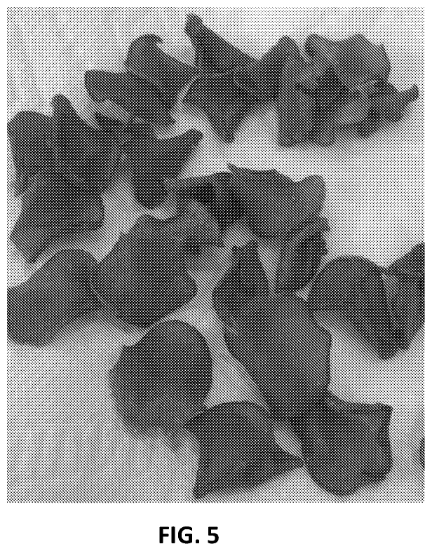

For example, FIG. 2 illustrates an example of a 2 mm thick slice taken transversely through a stipe of a Pleurotus eryngii mushroom and FIG. 3 shows a side view of an exemplary slice. The stipe region is fibrous and somewhat dense may allow the chip to retain its shape and provide a pleasant texture when frying. In contrast, the cap region may be avoided and excluded from the slices forming the chips, because it may result in a less desirable appearance, texture and flavor. FIG. 4 illustrates the slices of FIGS. 2 and 3 being fried in an oil at between, e.g., 145° C. and 190° C. (e.g., between about 300°-350° F.).

In general, any desired cooking oil may be used, such as safflower oil. Frying may proceed until the chips are an appropriate water activity (e.g., less than 0.6) and/or color, and/or for a predetermined amount of time (e.g., between 1 minute and 10 minutes, between 2 minutes and 6 minutes, etc.).

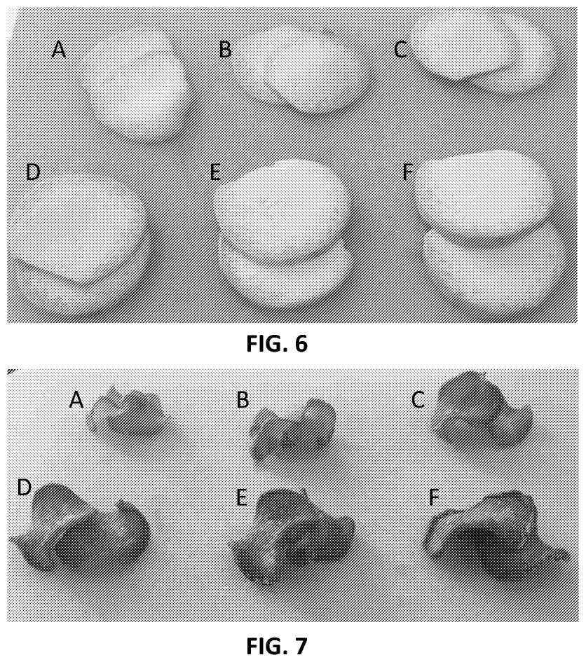

FIGS. 6 and 7 illustrate slices taken transverse to the long axis of the stipe at different thicknesses before and after frying. The different thickness shown include: 1 mm (A), 2 mm (B), 2.5 mm (C), 3 mm (D), 3.5 mm (E) and 4 mm (F). As will be discussed in greater detail below, chips formed of different slice thicknesses and/or slice angles, even when taken just from the stipe region, may have dramatically different flavor and crispness profiles.

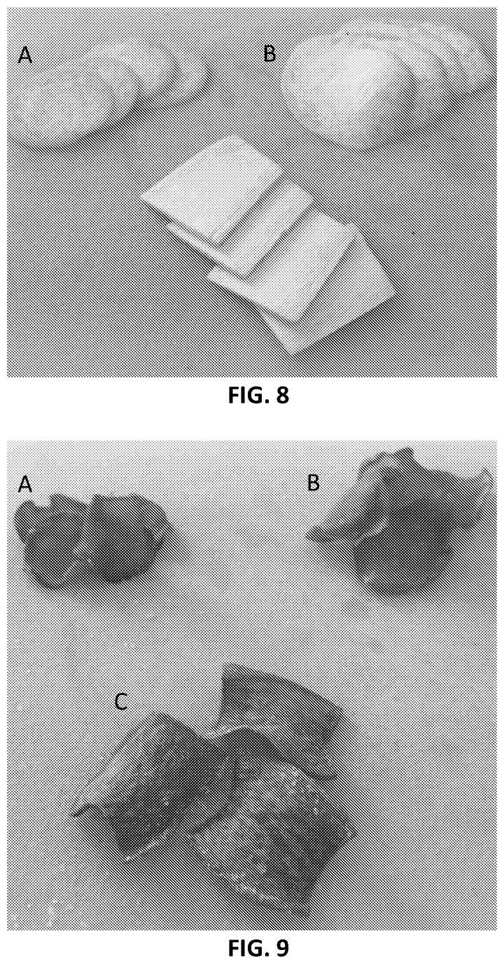

The direction of slicing (e.g., relative to the long axis of the stipe) may be important. For example, as shown in FIGS. 8 and 9, the slices may be made transverse to the long axis, shown in FIG. 8(A), or any angle between transverse (typically 90°+/− some amount, such as +/−30°, 25°, 20°, 15°, 10°, etc.) and 0°, shown in FIG. 8(C), including 45°, shown in FIG. 8(B). Surprisingly, slicing too much on the bias negatively affects crispness of chips.

After frying, the resulting chips may be smoked and/or seasoned. Surprisingly, smoking for a very brief time by saturating in smoke was found to be sufficient to impart a robust and long-lasting pleasant flavor. Unlike typical smoking techniques, which require extended exposure to the smoke (e.g., one or more hours) the methods described herein benefit from smoking for less than 10 minutes (e.g., between 1 minute and 10 minutes, between 1 minutes and 9 minute, between 2 minutes and 10 minutes, between 2 minutes and 8 minutes, between 2 minutes and 7 minutes, between 2 minutes and 6 minutes, etc.).

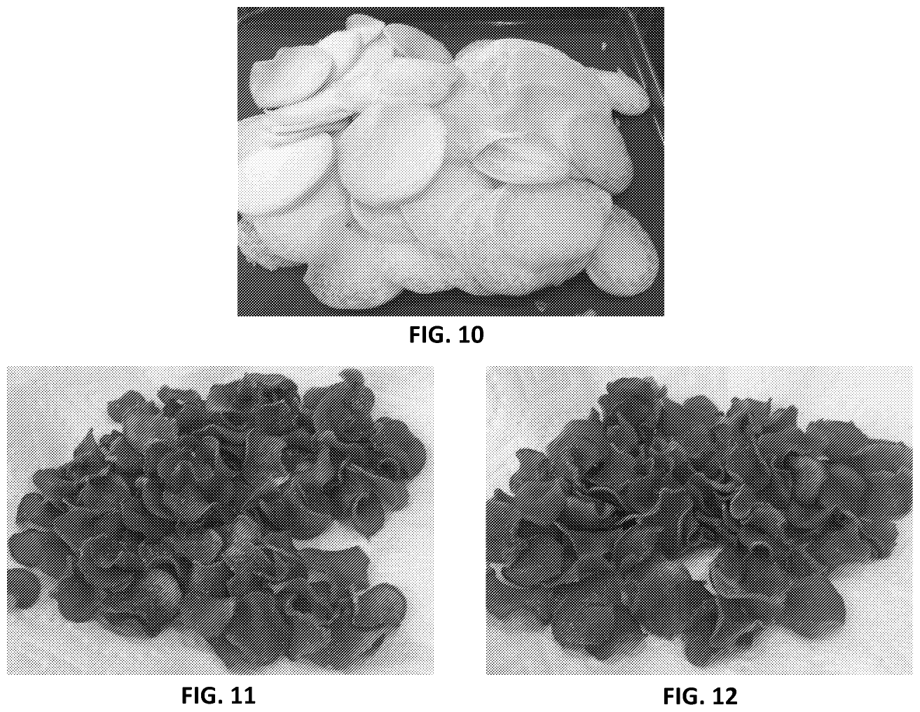

FIGS. 10-12 illustrate slices of Pleurotus eryngii mushroom pre-frying (show in FIG. 10), immediately after frying (shown in FIG. 11), and immediately after brief (<10 min) smoking and subsequent seasoning. These figures illustrate chips without any blocking agent (e.g., without the pre-frying impregnation steps described above). Any appropriate seasoning mix may be used, for example, sea salt, maple crystals, sea salt and maple crystals, etc. For example, in some variations a ratio of 4:1 (sea salt: maple crystals) may be used, e.g., a ratio of sea salt to maple crystals of between 2:1 and 6:1. Any other flavors may be used, and smoking may be an optional step.

As mentioned, the chips may be formed to have a relatively low water activity (wₐ). For example the water activity may be below 0.85, which is considered to be a shelf stable meat product by the Food Safety and Inspection Service, and is a requirement for shelf stability (USDA). The methods described herein may provide a water activity that is 0.6 or lower, which provides an extended shelf life for such “low moisture” foods. See, e.g., http://www.fda.gov/downloads/Food/GuidanceRegulation/FSMA/UCM517399.pdf, which describes water activity, including testing and guidance for stability.

When smoking the chips described herein, any appropriate method of smoking may be used, particularly those in which the gaseous smoke saturates the fried chips for a predetermined period of time not exceeding 10 minutes. Any “type” of smoke may be used, including in particular smoke (typically hot smoke) is formed by heating a wood such as cherry, hickory, apple, etc. Smoking the chips as described herein may enhance the meaty flavor of the chips. The smoke may be “hot”, e.g., formed at a temperature of between 200 degrees F. to 260 degrees F. (e.g., between 93 degrees C. to 127 degrees C.). The chips may be saturated for a period of between 1 minutes and 10 minutes (e.g., between 1 minute and 9 minutes, between 1 min and 8 minutes, etc.).

Typically, the finished chip dimensions may have a thickness that is between about 0.75 mm-2 mm (e.g. about 1 mm-1.5 mm) and a diameter of between about 2 cm-4.5 cm (e.g., between about 3 cm-3.5 cm). This may be in contrast to pre-frying chip dimensions such as a thickness of between about 1 mm-3 mm (e.g., approximately 2 mm) and a diameter of between about 4 cm-7 cm (e.g., between about 5 mm-6 mm).

Another factor that may affect the overall crispness and flavor of the chip is the relative condition of the starting mushrooms. Typically, fresher mushrooms are believed to work best, although in some cases it may be difficult to coordinate the relative freshness of the mushrooms, particularly in cases where the mushrooms have been pre-treated with a modified atmosphere packaging (“MAP”). Mushrooms that are greater than a week old (without being treated by, e.g., a modified atmosphere) may produce a chip having a mealy texture, a color that is much darker and a less pleasant flavor. Freshness may mean that the mushroom is used within about one week (e.g., with about 5 days, within about 6 days, within about 7 days, within about 8 days, within about 9 days, within about 10 days, within about 11 days, within about 12 days, within about 13 days, within about 14 days, within about 15 days, within about 16 days, within about, 17 days, within about 3 weeks, within about 3.5 weeks, etc.). Further, in instances where the mushrooms have been picked and packaged in a modified atmosphere (as described in in greater detail below), the above discussion of ‘freshness’ may not apply; in some cases, after exposure to a modified atmosphere (i.e., exposure of more than a day or two) it may be beneficial to provide a delay time of more than 24 hours, more than 36 hours, more than 48 hours, more than 60 hours, more than 72 hours, etc. from removing the mushrooms from the modified atmosphere before processing them as described herein; processing before this delay period may result in a less desirable texture (e.g., a mealy texture) and flavor (e.g., a more “mushroomy flavor”). Similarly, it may be beneficial to delay for 1 or more days (e.g., 1.5 days, 2 days, 2.5 days, 3 days, etc.) before processing the mushrooms as described herein. For both fresh and MAP exposed mushrooms, the delay period may help stabilize the mushrooms prior to processing, providing a consistent flavor, color and texture; mushrooms that are fresh or previously exposed to MAP that are processed sooner (e.g., within 1-2 days) may be more variable in flavor and texture; alternatively mushrooms processed after too long of delay, e.g., >7 days, >8 days, >9 days, >10 days, >11 days, >14 days, >15 days, etc. Thus, there may be an ideal range of times from picking (after an appropriate delay period but prior to a freshness limiting period) or from opening a package including a modified atmosphere.

Any of the methods described herein may include one or more optional manufacturing steps including de-oiling peeling the mushrooms.

In any of the variations described herein, even if MAP has not been used, the mushrooms may be pretreated to normalize them, which may help with consistency of flavor and product. For example, mushrooms may be exposed to air (e.g., sealed boxes may be opened, and any plastic bag/covering may be cut, exposing them to the air) and stored at approximately room temperature (e.g., about 70 degrees F./21° C.) for between about 1-36 hours (e.g., about 24 hours). They may then be stored in a cooler storage environment, including refrigerated, at a lower temperature (e.g., between about 4° C.-10° C., e.g., about 4° C.) for up to another 7-8 days before use (e.g., up to about 3-5 days in fridge). Without this additional normalization step, fried chips made from the mushrooms may be very dark and too hard, with an undesirable texture and mouthfeel. When pretreated as described above, the fried chips typically have an appealing golden-brown color and will have a crispy, desirable texture and mouthfeel.

In any of the variations described herein, it may be desirable to reduce the total fat content of the final chips to less than 40%. Typically, chips made by simply slicing and frying will have a fat content of greater than about 45% (e.g., between 50%-60%). This high fat content may be undesirable. Thus, described herein are mushroom chips formed as described that may have a fat content of 40% or less (e.g., 37% or less, 36% or less, 35% or less, 34% or less, 33% or less, 32% or less, 31% or less, 30% or less, etc.). In particular described herein are methods for impregnating the sliced chips with a blocking agent comprising a pregelatinized starch having a low (or zero) sugar content as described above for a period of time and at pre-frying time of, e.g., between 2-15 minute.

As mentioned above, in some variations it may be important to modify the sliced mushrooms by incorporating (e.g., by soaking) a blocking agent as described herein, which may act as a displacing agent when the mushroom is later fried, displacing fat that would otherwise be absorbed into the mushroom. Thus, any of the methods described herein may include a soaking step prior to frying the mushrooms (and typically, but not necessarily, after slicing), in which a solution including the displacing agent, e.g., pregelatinized starch, is incorporated into the chips to a predetermined level (e.g., typically between 1%-5% of the chip).

For example, any of these methods may include a soaking step as part of the manufacturing process. In the absence of a displacing agent, the final chips is typically between 50.0%-60.0% fat. In general, it is desirable to produce a chip having a maximum fat content of approximately 36.0% or less. The fat content of the final chip may be adjusted by soaking the mushrooms (e.g., sliced mushrooms, sliced as described herein) in a fat-displacing agent to achieve an impregnation of the displacing agent of between about 2%-10% (e.g., between about 2%-5%, etc.) prior to frying. Without being bound by a potential theory soaking in a displacing agent (e.g., a pregelatinized starch) may achieve this by absorbing the water soluble displacing agent into the mushroom slices. When the mushroom slices are subsequently fried, the water cooks out, but the mushrooms hold onto the majority of the soluble displacing agent; the soluble powder may take up space in the mushroom that would otherwise be taken up by oil, so the resulting fat percentage is lower.

The actual displacing agent may be important, as not all displacing agents will work, particularly with the Pleurotus eryngii mushrooms described herein. Pregelatinized starch in particular works well when frying in air (e.g., ambient frying, without requiring a vacuum). Ambient frying is particularly useful, as it does not require the additional expense and risk associated with other cooking (e.g., vacuum frying) methods. Not all polysaccharides, starches or sugars work as well as pregelatinized starches that are water soluble at or below room temperature (e.g., 25 degrees or less), and have a low viscosity as described above. For example, corn syrup, was inferior to maltodextrin (e.g., resulting in turning the chips very dark and burning/scorching them when fried). Other possible displacing agents such as Vitafiber (Isomaltooligosaccharide), a prebiotic fiber sweetener very low in sugar, was examined, but also did not work. Sugar alcohols such as xylitol and sorbitol, resulted in a chip having an unpleasant mouthfeel and texture. In addition, other starches (e.g., arrowroot and a modified wheat flour), also failed to displace oils during frying, as did soy protein; Xanthan gum was also less successful (and resulted in a chip having a strange mouth feel). In contrast, maltodextrin is highly soluble, and a solution of maltodextrin may be reused multiple times, enhancing ease of manufacturing. The maltodextrin produced a chip that did not burn and had a pleasant golden-brown color when fried in ambient conditions at less than 315° F. For example, sliced mushrooms (e.g., approximately 1 mm thickness) were soaked in a solution of maltodextrin and water. Either 10DE tapioca and/or 10DE corn maltodextrin was used, with similar, successful results. The solution may have a range of between about 5.0%-20.0% maltodextrin, e.g., between about 10.0%-15.0% maltodextrin. The soaking times between about 2 minutes-20 minutes (at room temperature), e.g., between about 5 minutes-10 minutes, were successful. In some variations, the mushroom slices were soaked for about 7 minutes in a 10% maltodextrin solution. Alternatively a 15% maltodextrin solution may be used, soaking for 5 minutes.

In some variations it may be preferable to use a pregelatinized starch having a low viscosity (as described above) instead of a maltodextrin as the blocking agent. The pregelatinized starch may be used with any of the parameters described above. Soaking temperature may be between 20° C.-50° C. In some variations, the mushrooms may be allowed to rest, e.g., for between 1-5 minutes (e.g., 3 minutes) after they soak and before frying, to allow any surface solution to soak into the mushrooms. In general, it may be desirable to treat the sliced mushrooms with the pregelatinized starch so that the range of pregelatinized starch pickup (absorption into the mushrooms) is between about 1% and 10% (e.g., between about 2%-6%, between about 3.0%-4.5%, between 1%-5%, etc.). In some variations, the method may include a 7 minute soak in 10% pregelatinized starch, which may result in the mushrooms having between 3.25%-4.0% pregelatinized starch following the soaking. The percentage of the pregelatinized starch in the chip after frying may be slightly higher, as the overall volume of the chip is reduced; for example, if the raw sliced mushroom takes up between 1%-5%, then the fried chip will have between about 8%-16%. For example, the fried chip may have a percent of pregelatinized starch of between about 3% and 22%, between about 5% and 20%, between about 6% and 18%, between about 4% and 21%, including preferably between about 5% and 20%.

The sliced mushrooms including pregelatinized starch may then be fried, as described above. For example the frying oil may be between 325° F.-365° F. (e.g., between 163° C.-185° C.). In some variations the frying temperature may be between 335° F.-360° F. (e.g., between 168° C.-182.2° C.).

As mentioned, any of the methods described herein (see, e.g., FIG. 1B) may also include drying, e.g., by baking, the chips after frying. Baking after frying may reduce the time that the chips spend in the fryer, allowing the chips to be “finished” in the oven, which may further reduce the ultimate fat percentage, and may aid in producing a consistent and uniform color and appearance. For example, chips may be baked following frying at a temperature range in the oven of between about 200° F.-350° F. (e.g., 93.3° C.-176.7° C.), for between about 6 minutes-20 minutes.

In any of the variations described herein a smoked maltodextrin powder (which may result in a flavor very similar to the smoked chips) may be used instead of smoking the chips. In some variations the smoked maltodextrin powder may be applied to the chips topically, along with the other seasonings, after they are fried.

The color of the final chip product is of particular interest in providing a viable product. Although in some instances the color may be unrelated to the nutritional value and/or the taste, color has been shown to be highly important in the perceptual experience of the consumer. As such, the methods and products (chips) described herein may be specifically directed to produce a mushroom chip that has a range of color values. For example, the color of the chips may be light brown to golden brown, and may avoid or minimize darker brown/blackened chips. Pregelatinized starch in particular, compared to other agents, when used as described above, produces a chip that had a pleasant golden-brown color when fried at less between 335-365° F.

Color may be measured by spectral analysis of the chips. For example, spectrophotometers may be used for precise color measurements. The color of the fried chips may be measured, for example using a ratio of absorbance values through spectral analysis. These measurements may be used for evaluation using a method such as the Hue Index, which usually ranges from 3.4 (very dark walnut brown) to 7.5 (amber red brown) for caramel colors (0.1% solution). For example, the chips described herein may have a hue (or hue index) corresponding to yellowish green (or just yellow) through orange. This method has various uses, and is heavily relied upon for the measurement of tea products and beer brewing color variations as well.

Alternatively or additionally, colorimetry may be used for color measurement. In colorimetry, the quantification of color is based on the three-component theory, looking at the three primary colors (red, green, and blue), and that all colors are seen as mixtures of these primaries. In colorimetry, these components are referred to as X-Y-Z coordinates. Colorimeters may employ at least three photocells as receptors to see color in much the same way as the human eye. Spectrophotometry may uses many more sensors (e.g., 40 or more in some spectrophotometers) to separate a beam of reflected or transmitted light into its component wavelengths. It measures the spectral reflectance of an object at each wavelength on the visible spectrum continuum. Colorimeters are generally used in production and quality control applications. If a CIELAB, L*a*b* coordinate system is used, then the methods and products described herein (e.g., chips) may be centered around the yellow/orange/red range (e.g., b>0.3, −0.2<a<0.3). In some variations, the L*a*b* color space for the mushroom chips may be configured to have a lightness (L*) of greater than 55 (e.g., between about 55 to 80, between about 50 to 85, between about 60 to 80, between about 50 to 70, greater than 50, greater than 60, etc.), with a chroma value (a*/b*) of less than about 0.3 (e.g., between about −0.2 to 0.3, 0.0 to 0.3, less than 0.3, less than 0.275, less than 0.25, less than 0.2, less than 0.175, less than 0.15, less than 0.1, etc.).

### EXAMPLE 1

FIG. 1A illustrates an exemplary method of making a chip having a meat flavor, as described herein. A similar alternative method is described below. Asterisks (*) indicate optional steps that may or may not be included either individually or collectively.

1.) *Washing (and Peeling)

2.) Slicing

3.) *Blanching

4.) *Rinsing and Cooling

5.) *Dehydrating

6.) Frying

7.) *De-Oiling

8.) *Seasoning

9.) *Packaging

Flavors that may be achieved with these chips may include bacon flavors including, for example, original bacon flavor, smoked bacon flavor, cherry bacon flavor, etc. In this example the seasoning may include: sea salt and maple crystals. The chips may be smoked as described herein using a cherrywood. Another flavor may include bacon cheddar; the seasoning may include: sea salt, maple crystals, natural cheddar cheese flavor, smoked with cherrywood. Another flavor is “hickory bacon”, which may include seasoning such as: sea salt and maple crystals, and may be smoked with Hickorywood. Another flavor may include “apple bacon” which may be achieved by seasoning the fried chips with sea salt and maple crystals following a brief smoking with Applewood. Other Meat Flavors may include “KC BBQ”, seasoning the chips with sea salt, maple crystals, BBQ herb & spice blend, smoked with Hickorywood, a “fried chicken” flavor chip, seasoned with sea salt, natural chicken flavor, herb & spice blend (without smoking), and an “Italian sausage” flavor chip, seasoned with sea salt, natural pork flavor, herb & spice blend (possibly smoked with cherry, hickory, or apple or possibly without smoking).

Herbs and spices that may be used for flavors may include one or more of: allspice, anise seed, annatto seed, asafoetida, bay leaf, celery salt, celery, seed, chili powder, curry powder, chives, basil leaf, cardamom, cayenne pepper, chipotle pepper, cilantro leaf, cinnamon, cloves, coriander seed, cumin seed, dill weed, fennel seed, fenugreek seed, five spice powder, garam masala, garlic powder/flakes/granules/salt/minced, ginger root, grains of paradise, green bell pepper, gumbo file powder, harissa, jalapeno chili, juniper berry, lemon peel, mace, marjoram leaf, mustard powder, mustard seed, onion powder/flakes/granules/salt/minced, orange peel, oregano leaf, nutmeg, paprika, parsley leaf, (ground) pepper (e.g., black, white, pink, red, green, etc.), peppercorn (e.g., black, white, pink, red, green, etc.), poppy seed, red bell pepper, rosemary leaf, saffron, sage leaf, salt, savory leaf, sesame seed, (black) sesame seed, star anise, szechuan peppercorn, tarragon leaf, thyme leaf, tomato powder, vegetarian beef flavor, vegetarian cheese flavor, vegetarian chicken flavor, vegetarian ham flavor, vegetarian lamb flavor, vegetarian pork flavor, vegetarian turkey flavor, and smoke powders (e.g., apple smoke powder, cherry smoke powder, hickory smoke powder, liquid smoke, and mesquite smoke powder).

Spices (including salts) may be added before or after smoking in variations that are smoked. For example, spices (e.g., sea salt and maple crystals) may be added before smoking.

In this example, the frying step may be performed using canola or safflower oil as the fryer oil. Alternatively, a sunflower/safflower blend may be used. Other variations may include coconut oil and algae oil or any other oil or mixture of oils, not limited to these. The frying temperature may be, e.g., between 300° F. and 360° F. (e.g., between 300-325° F., etc.) which may provide the best blend of appearance, flavor and crispiness. The frying time may vary, e.g., between 2 minutes and 10 minutes (e.g., between 4-8 minutes, etc.). In many of the examples described herein the chips are not fried under pressure.

In variations in which the chips are smoked, smoking may be performed for a predetermined time period during which the chips are surrounded (saturated) by the appropriate smoke. The duration of smoking may be important in maintaining a meat-like flavor that is pleasant but not overpowering. For example, if the smoking step proceeds for too long (e.g., >10 minutes), the flavor of the chips may be very unpleasant (e.g., reminiscent of creosote, bitter). As used herein saturation with the smoke typically refers to surrounding the chips with smoke for the smoking time. This may be accomplished using a commercial smoking container or smoker. For example, a Masterbuilt smoker or a Cookshack smoker (Smokette Elite Model SM025 Electric Smoker Oven) may be used, for example, by setting the smoker temperature to 260 degrees F. and preheat the smoker until the temperature readout is 260 degrees F. For example, the smokehouse of the smoker may be loaded with, e.g., ½ cup, of wood chips (e.g., Cherrywood, Hickorywood, Applewood, etc.) and allowing the smoker temperature to return to 260 degrees F. and watch the smoke coming out of the chimney until it is coming out in a steady stream (8-12 minutes from when the wood chips are added). The fried chips may then be placed (in this example, they have already been rinsed, sliced, fried, “de-oiled” and seasoned) on a perforated tray and put them in the smoker. The chips smoke from 1-8 minutes. The chips may then be removed from the smoker and air dried for 5-10 minutes and then “packaged” in airtight plastic containers.

The chips may be de-oiled following frying by any appropriate method, including by tossing them on an absorbent material (e.g., a paper plate) and/or lined with an absorbent material (such as a paper towel) frying them. Alternatively or additionally a de-oiling machine may be used; the de-oiling machine may use centrifugal force to separate excess oil on the chips, as the chips are essentially spun in a large colander inside a chamber. When the colander spins, the excess oil goes through the holes in the colander into the outer chamber, where it can be drained off from a spigot at the bottom of the chamber).

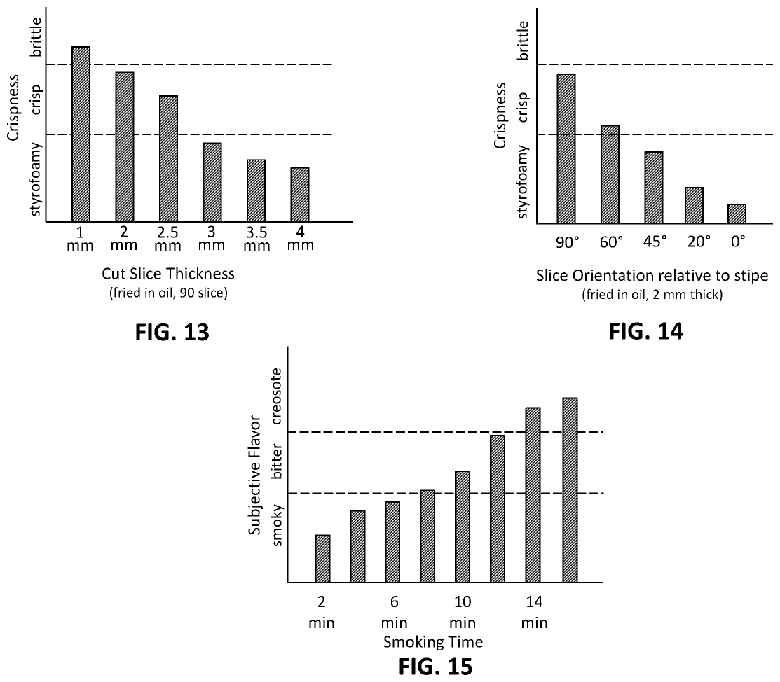

A chip-preparing method such described above was used to examine the parameters, particularly with respect to slice thickness, slice cutting angle relative to the long axis of the stipe, smoking time, and the like. FIGS. 13, 14 and 15 illustrate the results of these preliminary tests.

For example in FIG. 13, the effect of different slice thicknesses on crispness is shown. Table 1, below shows a similar comparison, including an indication of the effect of the thickness on flavor as well.

TABLE 1
Qualitative comparison of chip thickness

| Transverse | | |
|---|---|---|
| slice | Fry Time | |
| Thickness | (325° F.) | Observation |
| 1 mm | 2:00 | good crispiness, good density/mouthfeel, |
| | | good color (homogenous) but a little light |
| 2 mm | 2:45 | best crispiness, good density/mouthfeel, |
| | | good color (homogenous) |
| 2.5 mm | 3:30 | crispiness still acceptable, acceptable |
| | | density/mouthfeel, good color (homogenous) |
| 3 mm | 4:30 | starting to loose crispiness-slightly crumbly, |
| | | density/mouthfeel getting too “light” and |
| | | “styrofoamy”, color too dark and not homogenous |
| 3.5 mm | 5:30 | same as 3 mm, with each aspect getting a |
| | | little worse, starting to taste mushroomy |
| 4 mm | | all aspects progressively worse than 3.5 mm, |
| | | taste is very mushroomy |

As shown in both FIG. 13 and Table 1, the optimal range of thicknesses, particularly for transverse slices, e.g., slices taken at 90°+/−30° (and particularly +/−15°) relative to the long axis of the stipe, have a far superior crispiness, flavor and mouth-feel. Outside of this range (e.g., >3 mm thick), the crispiness and flavor are progressively worse.

FIG. 14 and Table 2, below show a similar effect on the sliced angle relative to the long axis of the mushroom. As shown, sections that are not transverse to the long axis (e.g., beyond about +/−30 degrees) also do not have sufficient crispness and flavor profiles, with slices taken in the long axis (“with the grain” at 0°) being the least desirable.

TABLE 2
Comparison of Bias Cut (all cut to a thickness of 2 mm)

| Cut | Fry Time (325° F.) | Observation |
|---|---|---|
| 90 degrees | 2:45 | perfect balance of color, |
| | | appearance, flavor, crispiness, |
| | | good density/mouthfeel |
| 45 degrees | 3:00 | color, appearance and flavor |
| | | good. A little too light, not |
| | | crispy enough, |
| | | density/mouthfeel not bad but |
| | | too light |
| with the grain | 6:00 | starting to loose crispiness- |
| | | slightly crumbly |
| | | density/mouthfeel too “light” |
| | | and “styrofoamy”, color too |
| | | dark and not homogenous |

In these examples, the range of frying time was between about 3-6 minutes. The optimal cut (2 mm, 90 degree angle) took about 3 minutes and 30 seconds. The seasoning range used was about 2-3% by weight of the raw chips (prior to frying), and the optimal range for the bacon flavor was found to be about 2.8% (seasoning was approximately 4:1, sea salt:maple crystals).

Similarly, FIG. 15 illustrates the ranges of smoking time for chips (2 mm diameter, 90° cut angle relative to the stipe long axis). In this example, the smoker used is a “Cookshack” smoker and optimal smoke conditions were found to be 3 minutes at 260° F. (Cherrywood chips). Thus, a range of between about 2 minutes to 6 minutes (e.g., 2 minutes to 4.5 minutes, etc.) may provide a good, consistent smoke flavor without “over smoking” (resulting in the overly bitter/creosote flavor).

### EXAMPLE 2

FIG. 1A illustrates another variation of a method of making mushroom chips as described herein. In FIG. 1A, the method may include the steps of pre-treating (e.g., normalizing) the uncut mushrooms by exposing to air at room temperature for a minimum amount of time (e.g., approximately 24 hours), followed by an optional refrigeration period (e.g., for up to 8 days, e.g., 3-5 days) 121. The mushrooms may then be washed and sliced, e.g., as described above. For example, the stipe of the fruiting body of the Pleuortus eryngii mushrooms may be sliced transversely to 1-3 mm thicknesses (e.g., approximately 1 mm) 122. A fat displacing agent (and particularly pregelatinized starch) may be absorbed into the thickness of the sliced mushroom, e.g., by soaking in a pregelatinized starch solution (e.g., 5%-30% pregelatinized starch in aqueous solution) until the slice includes between 1%-7% pregelatinized starch incorporated therein (e.g., between 2%-5%, etc.) 123. Thereafter, the sliced with the absorbed pregelatinized starch may be fried in oil (e.g., at between 335° F.-365° F.) until the water activity of the chips is 0.6 or less, leaving greater than 1% pregelatinized starch (e.g., between 1%-10%) within each chip 127. The chips may optionally be baked (e.g., dried/baked) 129; if a drying/baking step is included, the chips may be removed from the frying before the water activity is 0.6 or less, and may be dried by baking (e.g., between 200° F.-350° F.) until the water activity is 0.6 or less 129. The chips may also be further de-oiled 131 (e.g., by spinning, blotting, etc.). The slices may then be seasoned and/or smoked 133, and packaged.

The use of pregelatinized starch as a fat displacing or blocking agent during frying was examined and compared to chips made in the same manner, but without using absorbed pregelatinized starch. Chips manufactured as described above, but without absorbing pregelatinized starch prior to frying had a final percentage of oil of between 50%-60%, even after a de-oiling step was performed. Laboratory testing showed that the use of various displacement/blocking agents, and in particular pregelatinized starch as described above, reduced the final percentage of oil substantially, e.g., to less than 40% (e.g., less than 35%). For example, chips manufactured as described in FIG. 1B in which the mushrooms were normalized, sliced and soaked for 7 minutes in 10% pregelatinized starch solution, fried at 350° F. and seasoned, were found to have about 37.31% fat. Mushrooms soaked for 10 minutes in a 10% maltodextrin solution, fried at 350° F. and seasoned had approximately 33.57% fat.

A similar trend was observed for fat percentage when soaking for different times and frying at different temperatures while using maltodextrin. For example, soaking for 3 minutes in 10% maltodextrin and frying at 310° F. (no seasoning) had a fat content of approximately 45.14%; soaking for 5 minutes in 10% maltodextrin and frying at 303° F. (no seasoning) had a fat content of approximately 42.30%; soaking for 7 minutes in 10% maltodextrin and frying at 303° F. (no seasoning) had a fat content of approximately 39.64%. When the frying time was reduced but a drying/baking step was added, the percentage of fat also decreased. For example, soaking mushroom slices for 7 minutes in a 10% maltodextrin solution and frying at 305° F. (with a belt speed of 100, compared to the previous example in which belt speed was 75), followed by drying/baking for 6 min. at 250° F. had a fat content of approximately 38.29%; soaking mushroom slices for 7 minutes in a 10% maltodextrin solution and frying at 300° F. (with a belt speed of 150), followed by drying/baking for 6 min. at 300° F. had a fat content of approximately 31.28%.

With respect to pregelatinized starch, as soak time increased, even while the total amount of pregelatinized starch absorbed by the slices was nearly identical, the percent fat content dropped with longer soak and/or resting times prior to frying. The frying temperature also effected the total fat content. At lower frying temperatures, the total fat content was higher, all other factors being equal. For example a 3 min soak time (without a rest), using a 10% solution of blocking agent at a fryer temperature of 305 degrees F. had a 45.14% fat content. A 5 minute soak resulted in a fat content of 42.30%, while a 7 minute soak at the same parameters had a fat content of 39.64%.

### Additional Treatments

As mentioned herein, during any of the method for processing described herein, the sliced Pleurotus eryngii may be blanched and dried (e.g., dehydrated). Blanching may include dipping, spraying, or otherwise exposing the Pleurotus eryngii to boiling water, and removal after a brief, timed interval. The Pleurotus eryngii may then be cooled and/or dehydrated (e.g., by plunging into iced water or placing under cold running water) to halt the cooking process. The blanching process may be performed at between a temperature of 70° C.-100° C. for any appropriate time, such as between 5 seconds and 5 minutes (e.g., between 5-30 seconds, between 5-20 seconds, between 5 and 12 seconds, etc.). As mentioned, blanching may be performed or not performed on the sliced Pleurotus eryngii.

Following blanching, the Pleurotus eryngii slices may be dried or dehydrated. For example, steps similar to the de-oiling steps described herein (e.g., blotting and/or centrifugation) may be used. Alternatively or additionally, compressed air (e.g., an air knife) may be used to apply a blast of air to remove excess water after the blanching process. During a dehydration/drying step, the slices may be exposed to a relatively high heat (e.g., 90° C.-110° C., e.g., approximately 200° F.-225° F.) for a few minutes, such as between 1-10 minutes, between 2-7 minutes, between 3-5 min, etc.

Any of the methods described herein may also or alternatively include a step of peeling and/or washing the Pleurotus eryngii. For example, the Pleurotus eryngii may be washed and/or peeled prior to slicing (and/or after slicing). In some variations, the Pleurotus eryngii (or slices prepared as described above) may be rinsed and dried (e.g., by patting them dry).

### Exposure to Modified Atmosphere

In some variations the methods and apparatuses described herein are optimized or normalized for the use of mushrooms that have been exposed or held in a modified atmosphere for greater than a predetermined time period (e.g., greater than 2 hours, 4 hours, 8 hours, 10 hours, 12 hours, 14 hours, 16 hours, 20 hours, 24 hours, etc.). The modified atmosphere may be, e.g., an environment that has a typically reduced oxygen level compared to air (e.g., less than <20% Oxygen, less than 19% Oxygen, less than 18% Oxygen, less than 17% Oxygen, less than 16% Oxygen, less than 15% Oxygen, less than 14% Oxygen, less than 13% Oxygen, less than 12% Oxygen, less than 11% Oxygen, less than 10% Oxygen, etc. Alternatively or additionally, the modified atmosphere may have a greater CO₂ level compared to air (e.g., and greater than 1% CO₂, greater than 1.5% CO₂, greater than 2% CO₂, greater than 2.5% CO₂, greater than 3% CO₂, greater than 3.5% CO₂, greater than 5% CO₂, greater than 5% CO₂, greater than 6% CO₂, greater than 7% CO₂, greater than 8% CO₂, greater than 9% CO₂, greater than 10% CO₂, etc.). This modified atmosphere may be passively achieved and/or actively achieved. For example, the modified atmosphere may be achieved by packaging in a membrane having a higher permeability for Oxygen than CO₂, or vice versa.

In any of these variations, the mushrooms may be exposed to a coating agent, such as, for example a coating of chitosan and/or CaCl₂ prior to exposure to the modified atmosphere. For example, the mushrooms (Pleurotus eryngii mushrooms) may be coated with a coating solution prepared by dissolving (0.1% to 2%, e.g., 0.3%) chitosan, e.g., in an acetic acid solution (e.g., 0.5% acetic acid solution), and/or dissolving 0.5% to 5% (e.g., 2.0%) calcium chloride in deionized water. The pH value of solution (e.g., the chitosan solution) may be adjusted to pH 5.0 with NaOH solution. The Pleurotus eryngii mushrooms may be spray-coated with the solution and allowed to dry (e.g., using a fan at ambient temperature).

Pre-treatment or exposure of the Pleurotus eryngii to a modified (e.g., reduced oxygen, such as <20%) for greater than 12 hours (e.g., 24 hours) has a substantial impact on the texture and crispness of the chips formed as described herein. For example, a comparison between fresh Pleurotus eryngii, which were not exposed to a modified atmosphere within 24 hours of slicing and frying, as described above (e.g., slicing to approximately 2 mm thickness, transverse to the long axis of the stipe of the fruiting body) and mushrooms that were exposed to a modified atmosphere having less than 20% Oxygen for greater than 12 hours before preparation shows a significant difference in the crispiness and texture of the resulting chips. In this experiment, Pleurotus eryngii were prepared from mushrooms stored in a modified atmosphere (e.g., low O₂) for more than 12 hours and from mushrooms that were not stored in a modified atmosphere or that were stored for less than 6 hours within 24 hours of slicing and preparation. Chips formed as described herein using Pleurotus eryngii that were not held at a modified atmosphere for more than 12 hours did not have adequate crispness or mouth feel, and less than homogenous color. (subjectively described as “pringley”), compared to those that were formed from Pleurotus eryngii that were exposed to the modified atmosphere for greater than 12 hours within 24 hours of use. This was very surprising, because the raw mushrooms in both cases were otherwise indistinguishable. The exposure (e.g., the longer exposure) to the modified atmosphere may therefore alter the texture of the resulting chip.

Typically a modified atmosphere refers to an atmosphere that is not air (e.g., 21% O₂; 0.038% CO₂, 78% N₂) but may consist of a lowered level of O₂ and in some variations a heightened level of CO₂. As mentioned, the modified atmosphere may be applied by active (e.g., gas-flushing and/or compensated vacuum) or by passive methods. In gas-flushing the desired gas mixture is instilled in quantity into the packaging, pushing out the air, whereas in compensated vacuum the air is removed and the desired gas mixture then instilled.

Any of the methods described herein may include exposing the Pleurotus eryngii prior to or after slicing the chips as described herein to an acid solution (e.g., citric acid solution). For example, any of these methods may include exposure to a citric acid solution between about 0.1%-5% citric acid (e.g., greater than 0.1%, greater than 1%, greater than 5%, etc.).

### EXAMPLE 3

Another example of a method for forming chips that are sufficiently crisp (not chewy or styrofoamy) and flavored (not bitter, not mushroomy) is provided below. In this example, which tracks FIG. 1A (but may also apply to the method shown in FIG. 1B), the mushrooms are selected by diameter. The range is roughly 4 cm-7 cm, with 5 cm-6 cm being the ideal diameter. Mushrooms outside of that range may be saved for other uses. The mushrooms may be rinsed and patted dry. The cap of the mushroom is cut off transverse to the long axis off the stem and saved for other uses. The mushrooms are sliced 101 on a “meat” slicer, starting from the cap end. A thickness of 1 mm-3 mm is acceptable, e.g. 2 mm. There is usually a little bit of mushroom at the end that is unusable and is saved for other uses. Slices may optionally be blanched 103 and dried 105. As mentioned above, the mushrooms may then be treated with a fat displacing/blocking agent (e.g., pregelatinized starch, maltodextrin).

The sliced mushrooms are then fried 107 in oil, such as canola oil (other oils that have yielded good results are safflower oil, refined coconut oil and a sunflower/safflower blend). The optimal temperature for frying in this example may be between 335-365 degrees F. (resulting in a good balance of appearance, flavor and crispiness), although a range of 340-360 degrees F. may be preferred. The chips are turned halfway through the frying and fried until all of the water has visibly cooked out (e.g., 4-8 minutes). The chips may be “de-oiled” 109, e.g., by tossing them on a plate lined with an absorbent material (e.g., porous material, such as filter paper, etc.) and may be tossed with seasoning 113. The seasoning is this example is a blend of sea salt and maple crystals at a ratio of 4:1 (sea salt:maple crystals). Alternatively or additionally, the chips may be seasoned later in the process (e.g., after smoking).

The chips may be smoked 111. The smoker temperature is set to 260 degrees F. and preheated until the temperature is approximately 260 degrees F. The smokehouse is loaded with ½ cup of wood chips (e.g., Cherrywood, Hickorywood, Applewood, etc.). The smoker temperature is allowed to return to 260 degrees F. smoke is emitted (e.g., out of the chimney) until it is coming out in a steady stream (typically 8-12 minutes from when the wood chips are added in the setup described herein). The fried chips are placed on a perforated tray and put them in the smoker. The chips smoke from 2-8 minutes, then removed from the smoker and air dried for 5-10 minutes. Thereafter, the chips may be packaged in airtight container.

### Pregelatinized Starch

As described herein, the type of displacing agent may play an important role in how the fat displacing/blocking works and how this translates into qualities of the chip snack, including with the Pleurotus eryngii mushrooms. In some cases, the displacing agent is a pregelatinized starch that has been processed to break down at least some intermolecular such that the starch granules engage with more readily with water, and is typically used in cooking as a thickening or binding agent. As a fat displacing agent for fried mushrooms chips, pregelatinized starch may be soluble in non-heated water (e.g., cold), which may allow the pregelatinized starch to be readily absorbed with the water into the mushrooms uniformly distribute within the mushrooms. In some cases, pregelatinized starch has been found to reduce the fat percentage of a fried mushroom chip by about 20% compared to a fried mushroom without being soaked in a displacing agent. Compared to maltodextrin, pregelatinized starch can have a lower sugar content, which may play a role in how the coated mushrooms are processed. For example, during the frying process, mushrooms soaked with pregelatinized starch may result in less buildup and accumulation compared to maltodextrin. Such buildup may caramelize and bind with mushroom fines and create “candy” in the oil, and cause the chips to clump and burn. This “candy” may also build up and get caught in mechanical parts of the fryer, which could eventually cause the mechanical parts to jam. These factors can be important in a high throughput production environment where large volumes of mushrooms are continuously processed over a number of hours (e.g., 8 hour shifts or more).

In some cases, the pregelatinized starch may have a very low or zero sugar content. Sugar content may be quantified, for example, using dextrose equivalent (DE), which is a measure of reducing sugars present as expressed as a percentage on a dry basis relative to dextrose. Pregelatinized starch may have DE of no greater than about 5%. The low sugar content provides the ability to use a relatively high oil temperature during frying (ambient frying, without a vacuum) compared to when frying mushrooms coated in other displacing agents (e.g., as maltodextrin soaked mushrooms) without burning the mushrooms. For instance the frying oil may be greater than 315° F., or greater than 325° F. (e.g., greater than 157.2° C., or greater than 163° C.). In some variations, the frying oil can be up to about up to 365° F. (e.g., 185° C.). In some variations the frying temperature may be between 315° F.-365° F. (e.g., between 157.2° C.-185° C.). In some variations the frying temperature may be between 325° F.-365° F. (e.g., between 163° C.-185° C.). The relatively higher frying temperatures that the pregelatinized starch affords can result in chips having more consistent color, texture, flavor, and crispiness over a number of production cycles. In addition, the frying time can be reduced, thereby increasing hourly throughput of processing (e.g., by as much as 1.5 times). For example, the frying time can be between about 3-10 minutes. In some variations the frying time can be between about 3-6 minutes. In some variations the frying time can be less than about 6 minutes. Other desirable properties of the pregelatinized starch can include its ability to remain dissolved in solution for a long period of time (e.g., more than 12 hours), which may be conducive to a production environment, as well as the ability to measure its concentration in solution using refractometry techniques for quality control and ability to run continuous throughput during scale-up.

The chips processed using pregelatinized starch may have different qualities than those processed using other displacing agents, such as maltodextrin. For instance, pregelatinized starch treated mushroom chips may be crispier and have a lighter color (e.g., golden brown) compared to maltodextrin treated mushroom chips. The color of the chips may also more consistent over multiple chips compared to the maltodextrin treated mushroom chips. In some cases the pregelatinized starch chips have a color similar to a non-soaked chip (without a displacing agent). These quality changes may be due to the low sugar content, higher frying temperature, lower frying times, and/or the ability of the pregelatinized starch solution to distribute itself uniformly in the chip, as described above.

The pregelatinized starch may be derived from any source, including corn, rice, potatoes, wheat, and/or cassava. In some cases, a low viscosity pregelatinized starch is used since these pregelatinized starches, when mixed in water at relatively high concentrations, result in solutions having low viscosity. As opposed to high viscosity pre-gelatinized starch solutions, low viscosity pregelatinized starch solutions can allow the solution to quickly and evenly soak into the mushroom and block fat absorption during subsequent frying. Non-limiting examples of low viscosity pregelatinized starches may include PURE-COTE® (e.g., INSTANT PURE-COTE® B792) manufactured by Grain Processing Corporation headquartered in Muscatine, Iowa, U.S.A., BatterCrisp® modified starch manufactured by Cargill, Incorporated headquartered in Minnetonka, Minn., U.S.A., and Crisp Film® modified food starch manufactured by Ingredion Incorporated headquartered in Westchester, Ill., U.S.A.

The methods described herein can be used to produce a final chip having a target fat (e.g., oil) content. As described above, the target fat content can be less than a predetermined value (e.g., equal to or less than about 40% by weight). In some cases, the target fat content is within a range that balances a number of desirable characteristics of the final chip. For example, a fat content that is higher than an upper limit (e.g., about 40%) may be undesirable for consumers who want to reduce their fat consumption. A chip having higher levels of fat may also be unappetizingly greasy. On the other hand, a chip having a fat content that is too low may be lacking in taste and/or be unappealingly dry or hard. In some examples, the target fat content ranges between about 30%-45% (e.g., 30%, 33%, 35%, 37%, 40% or 45%) by weight. In some variations, the target fat content ranges between about 30%-40% (e.g., 30%, 33%, 35%, 37%, 39% or 40%) by weight.

As described herein, a number of processing parameters can influence the fat (e.g. oil) content of a final chip, such as the frying time, the “rest” time between soaking and frying (if any), the thicknesses of the slices, and/or the type of displacing agent. Generally, increasing the soak time and/or soak concentration of the pregelatinized starch solution may reduce the fat content of the final chip. It should be noted that soak time and/or concentration may not be the only determinants of how much of the pregelatinized starch solution is absorbed into the mushrooms. For instance, it was found that a first batch of mushrooms soaked for 3 minutes absorbed about 5% of the solution (by weight) resulted in chips having an oil content of about 45%; and a second batch of mushrooms soaked for 7 minutes in the solution (having the same concentration of pregelatinized starch) also absorbed about 5% of the solution but resulted in chips having an oil content of about 36%. Thus, although the soak time may be a factor, it may not be the only factor in determining the amount of pregelatinized starch is absorbed, at least for the king oyster mushrooms. This may have to do with the relative porosity or “sponginess” of the king oyster mushroom. Other types of mushrooms and/or other vegetables with more density and less “sponginess” may behave differently.

### EXAMPLE 4

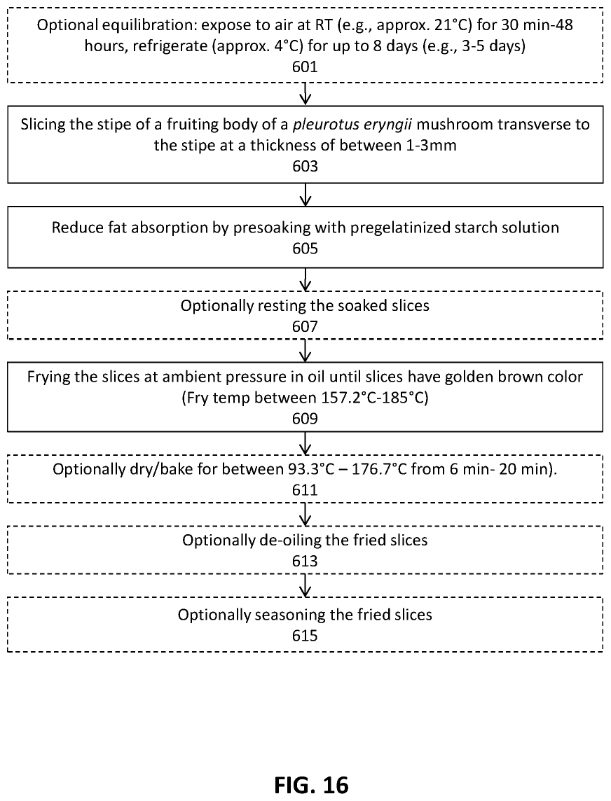

An example of a method for forming meaty flavored (e.g., bacon flavored) crispy Pleurotus eryngii mushroom chips using pregelatinized starch is provided below. In this example, which tracks FIG. 16, the method can include one or more aspects of the methods of FIGS. 1A and 1B described above. The method may include pre-treating (e.g., normalizing) the uncut mushrooms by exposing to air at room temperature for a minimum amount of time (e.g., approximately 24 hours), followed by an optional refrigeration period (e.g., for up to 8 days, e.g., 3-5 days) 601. The mushrooms may be sliced 603, for example, transverse to a stipe at 90°+/−30° relative to a long axis of the stipe to form a plurality of slices having an initial thickness of between 1 mm and 3 mm, and can include any of the slicing techniques described herein. The slices may optionally be blanched and dried.

Pregelatinized starch as a fat displacing agent may be absorbed into the thickness of the sliced mushroom, e.g., by soaking in a pregelatinized starch solution (e.g., at a concentration of 1%-25% pregelatinized starch in aqueous solution) 605. In some variations, the solution is prepared by mixing dried pregelatinized starch (e.g., INSTANT PURE-COTE® B792) in tap temperature water (e.g., about 20° C.-60° C.) using high shear for several minutes. Agitation/shear may be necessary for the pregelatinized starch to adequately dissolve and to avoid lumps from forming. In some variations, the mushrooms are soaked in the solution at a temperature between 20° C.-50° C. for about 1-120 minutes. In some variations, the soak time is between about 1-30 minutes. In some variations, the soak time is between about 1-10 minutes (e.g., 1, 3, 4.5, 5, 6.5, 7, 9.25 or 10 minutes). The soaking time can vary depending on, for example, the size and porosity of the mushrooms, solution temperature and/or other factors. In some cases, the mushrooms slices may be soaked until they have about 2%-10% (by weight) pregelatinized starch soaked therein. In some cases, the slices may be soaked until they have about 3%-6% (by weight) pregelatinized starch soaked therein. In some variations, vacuum tumbling may be implemented to reduce the soak time. After soaking, the mushroom slices are taken out of the solution and optionally allowed to “rest” out of solution for period (e.g., 1-10 minutes) out of the solution 607. This rest period may allow some of the solution on surfaces of the mushrooms slices to absorb into the mushroom slices.

Thereafter, the sliced mushrooms with the absorbed pregelatinized starch may be fried in oil (e.g., canola oil, safflower oil, refined coconut oil, and/or sunflower/safflower blend) until the slices take on a desired color (e.g., golden brown) 609. As described herein, the pregelatinized starch agent allows for generally higher frying temperatures without burning the mushroom slices, compared to a maltodextrin agent. For example, the frying oil can have a temperature of between about 157° C.-185° C. (e.g., 160° C., 175° C. , 180° C. or 185° C.). The frying time vary depending, in part on the temperature, and may range between about 3-10 minutes (e.g., 3, 5, 6, 8 or 10 minutes). In some variations, the mushroom slices may be fried until the water activity of the chips is below a predetermined value (e.g., 0.6 or less). The chips may optionally be baked (e.g., dried/baked) 611. If a drying/baking step is included, the chips may be removed from the frying before the water activity is below the predetermined value (e.g., 0.6 or less), and may be dried by baking (e.g., between 200° F.-350° F.) until the water activity is below the predetermined value (e.g., 0.6 or less). The chips may optionally be de-oiled 613 (e.g., by spinning, blotting, etc.). The chips may then optionally be seasoned and/or smoked 615, and packaged.

The chip snack may be characterized by fat content, percentage of pregelatinized starch absorbed therein, color, and water activity. The fat (e.g., oil) content may be measured as ranging between about 30%-40% (e.g., 37.3%, 34.6%, etc.) by weight. The chips (e.g., body) may have 3%-6% of pregelatinized starch absorbed therein. The color of (e.g., of the fruiting body) of the mushroom chips, in the CIELAB color space, may have lightness value (L*) of greater than 55 and a chroma (a*/b*) of less than about 0.3. The chips may have a water activity of 0.6 or less.

### Alternative Mushrooms and Snack Shapes

Although many of the examples described herein include Pleurotus eryngii mushrooms, the methods and foods described herein are not necessarily limited to any type of mushroom, or to any particular type of vegetable. For example, in some cases, button mushrooms and/or shitake mushrooms is used. Further, the snacks described herein may have different shapes and sizes and are not necessarily limited to chips (slices). For instance, the snacks can include whole mushrooms or mushrooms cut into cubes. The processing parameters can be adjusted accordingly to attain predetermined qualities of the snack, such as flavor (e.g., meaty, bacon-flavor), texture, crispiness, aroma, and/or fat (e.g., oil) content.

In addition, as mentioned above, the methods and techniques described above may be used to produce other types of chips, including vegetable chips, such as potato, sweet potato, etc. chips. The methods described above were used to generate a snack chips from russet potatoes and sweet potatoes. In particular, the methods of forming the snack chip (slicing to a comparable thickness as the mushrooms described above) may include soaking in a solution of pregelatinized starch (e.g., between 8-10% by weight) to reduce the fat content. For example, without a pre-frying soak in a pregelatinized starch the resulting chips (fried at 325 degrees) had a fat content of about 39.09% for russet potatoes, when fried at 325 degrees F. However, when the sliced russet potatoes are soaked in pregelatinized starch (e.g., Pure-Cote 10% solution) for 45 minutes and fried at 325 degrees F., they had a 34.20% by weight fat content. Similarly, sweet potatoes showed a similar or nearly identical pattern. Sweet potatoes sliced and fried at 300 degrees F. without impregnating a blocking agent that were fried at 300 degrees F. had a 42.99% fat content by weight, while similarly treated sweet potatoes that were soaked prior to frying in a blocking agent (e.g., Pure-Cote, 10% solution) for 45 minutes and fried at 300 degrees F. had a 37.67% fat content by weight. Preliminary results show that the pregelatinized starch blocking agent had a profound impact on fat content when applied in the correct manner.

Any of the methods described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1-43. (canceled)

44. A method of forming a snack chips using a continuous process, the method comprising:
slicing a vegetable to form a plurality of slices having an initial thickness of between 1 mm and 3 mm;
soaking the plurality of slices in a solution of pregelatinized starch for greater than 7 minutes until the plurality of slices are impregnated with between 1%-6% of pregelatinized starch;
frying the plurality of slices at ambient pressure in oil at between 168° C. and 185° C. to reduce the water activity of the plurality of slices; and
wherein the plurality of slices have a final percentage of fat by weight of less than 40%, and a water activity of 0.6 or less.

45. The method of claim 44, wherein the vegetable comprises potatoes.

46. The method of claim 44, wherein soaking comprises soaking in an aqueous solution of greater than 10% pregelatinized starch at less than 25 degrees C. for greater than 7 minutes.

47. The method of claim 44, further comprising resting the plurality of slices prior to frying for between 2 minutes and 30 minutes.

48. The method of claim 44, further comprising continuously repeating the steps of slicing, soaking and frying using the same oil for frying, for at least six hours.

49. The method of claim 44, wherein frying comprises frying for between 2 minutes and 6 minutes.

50. The method of claim 44, wherein frying comprises frying in one or more of: corn oil, safflower oil, sunflower oil, soybean oil, cotton seed oil, and sesame seed oil, avocado oil, olive oil, peanut oil, canola oil, algae oil, almond oil, organ oil, coconut oil, rice bran oil, flax seed oil, grape seed oil, hemp oil, mustard oil, macadamia oil, palm oil, peanut oil, pumpkin seed oil, soybean oil, tea seed oil, and walnut oil.

51. The method of claim 44, further comprising normalizing the plurality of slices prior to slicing them by exposing them to air at between 65° F. and 75° F. for approximately 24 hours and refrigerating for up to 8 days.

52. The method of claim 44, further comprising drying the plurality of sliced after frying them by baking at between 200° F.-350° F.

53. The method of claim 44, wherein the fat content of the fried chips is 37% or less.

54. The method of claim 44, further comprising seasoning the plurality of slices with one or more of: maple crystals, sea salt, cheese flavor.

55. A method of forming snack chips using a continuous process, the method comprising:
normalizing a potato by exposing to air at between 65° F. and 75° F. for approximately 24 hours and refrigerating for up to eight days;
slicing the potato to form a plurality of slices having an initial thickness of between 1 mm and 3 mm;
soaking the plurality of slices in a solution of 10% or more of pregelatinized starch for greater than 6 minutes to impregnate the plurality of slices for 7 minutes or more until the plurality of slices each contain between 1%-6% of pregelatinized starch;
frying the plurality of slices at ambient pressure in oil at between 168° C. and 185° C. to reduce the water activity of the plurality of slices; and
seasoning the plurality of slices, wherein the plurality of slices have a final thickness of between 0.7 mm and 2.2 mm and a diameter of between about 2 cm and 5 cm, a water activity of 0.6 or less, and a percent of fat by weight of 40% or less.

56. The method of claim 55, further comprising drying the plurality of sliced after frying them by baking at between 200° F.-350° F.

57. The method of claim 55, wherein the fat content ranges from 30% and 40%.

58. The method of claim 55, wherein the solution has a temperature of between 20° C. and 60° C.

59. The method of claim 55, further comprising removing the plurality of slices from the solution and allowing the plurality of slices to rest outside of the solution for a time ranging from 1 minute and 10 minutes prior to frying.

60. The method of claim 55, wherein the pregelatinized starch is derived from corn.

61. The method of claim 55, wherein the pregelatinized starch is a low viscosity pregelatinized starch.

62. The method of claim 55, further comprising agitating the slices while in the solution.

63. The method of claim 60, wherein the pregelatinized starch has a dextrose equivalent no greater than about 5%.
